(19) United States
(12) Patent Application Publication
(10) Pub. No.: US 2009/0251642 A1
(43) Pub. Date: Oct. 8, 2009

(54) RETARDATION FILM, BRIGHTNESS ENHANCEMENT FILM, POLARIZING PLATE, PRODUCING METHOD OF A RETARDATION FILM, AND LIQUID CRYSTAL DISPLAY

(76) Inventors: Runa Nakamura, Tokyo-to (JP); Hiroki Nakagawa, Tokyo-to (JP); Takashi Kuroda, Tokyo-to (JP); Yuya Inomata, Tokyo-to (JP); Masanori Fukuda, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 12/374,113

(22) PCT Filed: Jul. 17, 2007
(86) PCT No.: PCT/JP2007/064119

§ 371 Date: Jan. 16, 2009

(30) Foreign Application Priority Data
Jul. 18, 2006 (JP) 2006-196216
Sep. 29, 2006 (JP) 2006-270020
Nov. 15, 2006 (JP) 2006-309303

(51) Int. Cl. G02F 1/1347; G02F 1/13; B29D 7/01; G02B 1/08

(52) U.S. Cl. 349/75; 349/194; 264/1.34; 359/500

(57) ABSTRACT

A retardation film that is used as a polarizing plate protective film, thereby making it possible to yield a polarizing plate which is very good in durability and has a viewing angle compensation function. The retardation film has: an optical anisotropic film, in which a relation of nx>ny is realized between a refractive index “nx” in a slow axis direction of an in-plane direction and a refractive index “ny” in a fast axis direction of the in-plane direction; and a retardation layer formed on the optical anisotropic film and containing a liquid crystalline material, in which a relation of nx≦ny<nz is realized between refractive indexes “nx” and “ny” in arbitrary directions “x” and “y” of an in-plane direction which are perpendicular to each other and a refractive index “nz” in a thickness direction. The optical anisotropic film uses a transparent substrate having a cellulose derivative.

### TECHNICAL FIELD

The present invention relates to a retardation film used suitably as a polarizing plate protective film, a brightness enhancement film, a polarizing plate, a producing method of a retardation film, and others.

### BACKGROUND ART

Owing to the characteristics of such as power saving, lightweight and thin shape, the liquid crystal displays have recently been spread at a high rate instead of the conventional CRT displays. As a common liquid crystal displays, one comprising an incident side polarizing plate 102A, an output side polarizing plate 102B and a liquid crystal cell 104 as shown in FIG. 15 can be presented. The polarizing plates 102A and 102B are provided for selectively transmitting only a linear polarization having an oscillation plane in a predetermined oscillation direction, disposed in a crossed Nicol state with their oscillation directions perpendicular with each other. Moreover, the liquid crystal cell 104 includes a large number of cells corresponding to the pixels and is disposed between the polarizing plates 102A and 102B.

As such liquid crystal displays, those of various driving systems have been known according to the alignment form of the liquid crystal materials comprising the liquid crystal cell. The mainstream driving systems of the recent liquid crystal displays are classified into such as a TN, an STN, an MVA, an IPS and an OCB. In particular, liquid crystal displays having an MVA driving system and an IPS driving system are widely used.

In the meantime, liquid crystal displays have, as a problem peculiar thereto, a problem about viewing angle dependency resulting from the refractive index anisotropy of their liquid crystal cells or polarizing plates. This problem about viewing angle dependency is a problem that between a case where a liquid crystal display is viewed from the front and a case where the display is viewed in an oblique direction, the color tone or contrast of viewed images is unfavorably varied. About such a problem regarding viewing angle properties, seriousness of the problem has been increasing as the screens of liquid crystal displays have been made larger in recent years.

In order to overcome such a problem about viewing angle dependency, various techniques have been developed up to the present. A typical method thereof is a method using a retardation film. Such a method using a retardation film is a method as illustrated in FIG. 16, wherein retardation films 103 having predetermined optical characteristics are arranged between a liquid crystal cell 101 and polarizing plates 102A and 102B, thereby overcoming the problem about viewing angle dependency. This method makes it possible to overcome the problem about viewing angle dependency only by incorporating the retardation films 103 into a liquid crystal display, therefore, the method has widely been used as a method capable of yielding, with ease, a liquid crystal display very good in viewing angle properties.

As the retardation films, known are generally, for example, retardation films each having a structure wherein a retardation layer containing a liquid crystalline material in a regular sequence state is formed on a transparent substrate, and retardation films each made of a stretched film.

The main current in recent years has become not a manner in which retardation films are arranged separately from polarizing plates as illustrated in FIG. 16, but a manner in which retardation films are used to function also as polarizing plate protective films which constitute the above-mentioned polarizing plates. Specifically, as illustrated in FIGS. 17A and 17B, an ordinary liquid crystal display has a structure wherein polarizing plates 102A and 102B are arranged on both sides of a liquid crystal cell 101. Usually, the polarizing plates 102A and 102B each have a structure wherein a polarizer 111 is sandwiched between two polarizing plate protective films 112a and 112b (FIG. 17A) (hereinafter, for the convenience of description, the polarizing plate protective film 112a, which is arranged on the liquid crystal cell 101 side, is referred to as the “inside polarizing plate protective film”, and the other polarizing plate protective film 112b is referred to as the “outside polarizing plate protective film”). In a case where retardation films 103 are used to improve the viewing angle properties of the liquid crystal display, the main current in recent years has become a manner as illustrated in FIG. 17B, wherein polarizing plates 102A′ and 102B′ are used in each of which one of the retardation films 103 is used as the inside polarizing plate protective film 112a out of the two polarizing plate protective films 112a and 112b.

As each of the polarizing plate protective films used in the polarizing plates, known are a film made of a cellulose derivative, a typical example of which is cellulose triacetate, and a film made of a cycloolefin resin, a typical example of which is norbornene based resin. The cellulose derivative has an advantage that the derivative can cause water contained in a polarizer in the step of producing a polarizing plate to be volatized and scattered through the film since the cellulose derivative is very good in water permeability. Moreover, the derivative is also good in adhesion property to a polarizing film made mainly of PVA, so as to produce an advantage of giving a good workability or yield.

However, the derivative has a drawback that relatively large are the dimension change based on moisture-absorption in a high-temperature and high-humidity atmosphere and the fluctuation in optical characteristics. Furthermore, the polarizing plate protective film made of a cellulose derivative has an aspect that the gas barrier property is poor. For this reason, the film has a problem that the durability of optical characteristics of a polarizing plate falls when polarizing plate protective films made of a cellulose derivative are used on both sides thereof.

In the meantime, the above-mentioned cycloolefin resin has an advantage that relatively small are the dimension change based on moisture-absorption in a high-temperature and high-humidity atmosphere and the fluctuation in optical characteristics since the resin is a hydrophobic resin. However, the resin has a drawback that the resin cannot cause water contained in a polarizer in the step of producing a polarizing plate to be volatized and scattered through the film. For this reason, the film has a problem that the polarization property falls with the passage of time when polarizing plate protective films made of a cycloolefin resin are used on both the sides.

From such matters, it is stated that it is desired for each of the above-mentioned polarizing plates to use a polarizing plate protective film made of a cellulose derivative as the inside polarizing plate protective film and use a polarizing plate protective film made of a cycloolefin resin as the outside polarizing plate protective film. This is because this embodiment can have the advantages of the two together with each other and cancel the drawbacks of the two so that a polarizing plate very good in durability can be obtained. Accordingly, it is stated that when the above-mentioned retardation films are used, it is desired to use the films of such an embodiment (for example, Patent Document 4).

Incidentally, the retardation property which a retardation film as described above has depends on the driving manner of a liquid crystal display that becomes a target having a viewing angle property which should be improved, and others. In particular, in liquid crystal displays in an IPS (in-plane switching) mode, a retardation film having a nature as a positive C plate is used. Patent Documents 1 to 3 each discloses, as a retardation film used in such an IPS mode liquid crystal display, a film having a structure wherein a retardation layer having a nature as a positive C plate is formed on a transparent substrate made of a cycloolefin resin.

In a retardation film having a structure as disclosed in Patent Documents 1 to 3, a transparent substrate made of a cycloolefin resin, which has a low hygroscopicity, is used, therefore, the film has advantages that the film scarcely absorbs humidity or expands even in a high-temperature and high-humidity atmosphere, and further the durability of optical characteristics thereof is also good.

However, when such a retardation film, wherein a transparent substrate made of a cycloolefin resin is used, is used as an inside polarizing plate protective film as described above, it is unavoidable to use a polarizing plate protective film made of a cellulose derivative as the corresponding outside polarizing plate protective film. Thus, there is caused a problem that it is impossible to realize the above-mentioned desired use embodiment of polarizing plates.

From such a matter, there remains a problem that according to the retardation film wherein a transparent substrate made of a cycloolefin resin is used, a polarizing plate very good in durability cannot be obtained when the film is caused to function also as a polarizing plate protective film.

Patent Document 1: Japanese Patent Application Laid-Open (JP-A) No. 2002-174725

Patent Document 2: JP-A No. 2003-121853

Patent Document 3: JP-A No. 2005-70098

Patent Document 4: Japanese Patent No. 3132122

### DISCLOSURE OF THE INVENTION

### Problems to be Solved by the Invention

The present invention has been made in light of such problems, and a main object thereof is to provide a retardation film that is used as a polarizing plate protective film, thereby making it possible to yield a polarizing plate which is very good in durability and has a viewing angle compensation function.

### Means for Solving the Problems

To solve the problems, the present invention provides a retardation film, comprising: an optical anisotropic film, in which a relation of nx>ny is realized between a refractive index “nx” in a slow axis direction of an in-plane direction and a refractive index “ny” in a fast axis direction of the in-plane direction; and a retardation layer formed on the optical anisotropic film and containing a liquid crystalline material, in which a relation of nx≦ny<nz is realized between refractive indexes “nx” and “ny” in arbitrary directions “x” and “y” of an in-plane direction which are perpendicular to each other and a refractive index “nz” in a thickness direction, characterized in that the optical anisotropic film uses a transparent substrate comprising a cellulose derivative.

According to the invention, as the above-mentioned optical anisotropic film, a film having a transparent substrate comprising a cellulose derivative is used, whereby at the time of using the retardation film of the invention as an inside polarizing plate protective film, a polarizing plate protective film comprising a cycloolefin resin can be used as the corresponding outside polarizing plate protective film. For this reason, a polarizing plate very good in durability can be obtained.

Moreover, according to the invention, the retardation layer satisfies the relation of nx≦ny<nz, and further the optical anisotropic film satisfies the relation of nx>ny, therefore, when the retardation film of the invention is used as a polarizing plate protective film, a polarizing plate having a viewing angle compensation function for IPS mode liquid crystal displays can be obtained.

From such matters, according to the invention, a retardation film can be obtained which is very good in durability and makes it possible to yield a polarizing plate having a viewing angle compensation function when the retardation film of the invention is used as polarizing plate protective film.

In the present invention, the optical anisotropic film preferably has: the transparent substrate, and an optical anisotropic layer formed on the transparent substrate and containing a urethane resin. When the optical anisotropic film has this structure, the wavelength dependency of the retardation of the optical anisotropic film is easily made into a reverse dispersion type.

Further in the present invention, the optical anisotropic film preferably has: the transparent substrate, and the optical anisotropic layer formed on the transparent substrate and containing the cellulose derivative, which constitutes the transparent substrate, and an optical anisotropic material having a retardation exhibiting a wavelength dependency of a normal dispersion type. Even when the optical anisotropic film has this structure, the wavelength dependency of the retardation of the optical anisotropic film can be made into a reverse dispersion type. Moreover, when the film has this structure, the wavelength dependency of the retardation of the optical anisotropic film is easily adjusted into a desired mode.

In the invention, it is also preferable that the cellulose derivative is triacetylcellulose. Since triacetylcellulose has a retardation exhibiting a wavelength dependency of a reverse dispersion type, the use of triacetylcellulose makes it easy to make the wavelength dependency of the retardation of the optical anisotropic film into a reverse dispersion type.

Triacetylcellulose is also very good in optical isotropy and bondability to a polarizer.

In the invention, it is also preferable that the optical anisotropic material contains a monofunctional polymerizable liquid crystal compound having, in the molecule thereof, a single polymerizable functional group. This makes it possible to render the optical anisotropic film a film very good in the performance of expressing optical anisotropy.

Further, the present invention provides a brightness enhancement film, comprising: the retardation film of the above-mentioned embodiment, and a cholesteric liquid crystal layer formed on the retardation layer of the retardation film, and containing a liquid crystalline material in a cholesteric sequence state.

According to the invention, the use of the retardation film according to the invention makes it possible to yield a brightness enhancement film very good in brightness enhancement function, using the film as a polarizing plate protective film.

The present invention also provides a polarizing plate, comprising: the retardation film of the above-mentioned embodiment, a polarizer formed on the optical anisotropic film of the retardation film, and on a side opposite to the retardation-layer-formed side of the optical anisotropic film, and a polarizing plate protective film formed on the polarizer.

According to the invention, the use of the retardation film according to the invention as the polarizing plate protective film on one of both the sides makes it possible to yield a polarizing plate that is very good in durability and further has a viewing angle compensation function for an IPS mode liquid crystal display.

The present invention further provides a polarizing plate, comprising: the brightness enhancement film of the above-mentioned embodiment, a polarizer formed on the optical anisotropic film of the brightness enhancement film, and on a side opposite to the retardation-layer-formed side of the optical anisotropic film, and a polarizing plate protective film formed on the polarizer.

According to the invention, the use of the brightness enhancement film according to the invention as the polarizing plate protective film on one of both the sides makes it possible to yield a polarizing plate that is very good in durability and further has a brightness enhancement function.

The polarizing plate protective film preferably comprises a cycloolefin resin or an acrylic resin. This makes it possible to render the polarizing plate of the invention a polarizing plate very good in durability of optical characteristics.

The present invention further provides a producing method of a retardation film, comprising steps of: an optical anisotropic film forming step of using a transparent substrate comprising a cellulose derivative, coating on the transparent substrate an optical-anisotropic-layer-forming coating solution in which an optical anisotropic material having a retardation exhibiting a wavelength dependency of a normal dispersion type is dissolved in a solvent, and thereby forming an optical anisotropic film in which an optical anisotropic layer is formed on the transparent substrate; a stretching step of stretching the optical anisotropic film formed in the optical anisotropic film forming step; and a retardation layer forming step of forming, on the optical anisotropic layer of the optical anisotropic film stretched in the stretching step, a retardation layer containing a liquid crystalline material, in which a relation of nx≦ny<nz is realized between refractive indexes “nx” and “ny” in arbitrary directions “x” and “y” of an in-plane direction which are perpendicular to each other and a refractive index “nz” in a thickness direction.

The present invention also provides a producing method of a retardation film, comprising steps of: an optical anisotropic film forming step of using a transparent substrate comprising a cellulose derivative, coating on the transparent substrate an optical-anisotropic-layer-forming coating solution in which an optical anisotropic material having a retardation exhibiting a wavelength dependency of a normal dispersion type is dissolved in a solvent, and thereby forming an optical anisotropic film in which an optical anisotropic layer is formed on the transparent substrate; a retardation layer forming step of forming, on the optical anisotropic layer of the optical anisotropic film formed in the optical anisotropic film forming step, a retardation layer containing a liquid crystalline material, in which a relation of nx≦ny<nz is realized between refractive indexes “nx” and “ny” in arbitrary directions “x” and “y” of an in-plane direction which are perpendicular to each other and a refractive index “nz” in a thickness direction, thereby forming an optical laminate in which the retardation layer is formed on the optical anisotropic layer; and a stretching step of stretching the optical laminate formed in the retardation layer forming step.

According to the invention, as the above-mentioned transparent substrate, a substrate comprising a cellulose derivative is used, thereby making the following possible: when the retardation film produced by the invention is used as, for example, an inside polarizing plate protective film, a polarizing plate protective film comprising a cycloolefin rein is used as the corresponding outside polarizing plate protective film. As a result, a polarizing plate very good in durability can be yielded. From such a matter, a retardation film capable of producing a polarizing plate excellent in durability can be produced according to the invention.

The present invention provides a producing method of a retardation film, comprising steps of: an optical anisotropic film forming step of using a transparent substrate comprising a cellulose derivative, coating on the transparent substrate an optical-anisotropic-layer-forming coating solution in which an optical anisotropic material having a retardation exhibiting a wavelength dependency of a normal dispersion type is dissolved in a solvent, and thereby forming an optical anisotropic film in which an optical anisotropic layer is formed on the transparent substrate; a stretching step of stretching the optical anisotropic film formed in the optical anisotropic film forming step; and a retardation layer forming step of forming, on a surface opposite to the optical-anisotropic-layer-formed surface of the optical anisotropic film stretched in the stretching step, a retardation layer containing a liquid crystalline material, in which a relation of nx≦ny<nz is realized between refractive indexes “nx” and “ny” in arbitrary directions “x” and “y” of an in-plane direction which are perpendicular to each other and a refractive index “nz” in a thickness direction.

Further, the present invention provides a producing method of a retardation film, comprising steps of: an optical anisotropic film forming step of using a transparent substrate comprising a cellulose derivative, coating on the transparent substrate an optical-anisotropic-layer-forming coating solution in which an optical anisotropic material having a retardation exhibiting a wavelength dependency of a normal dispersion type is dissolved in a solvent, and thereby forming an optical anisotropic film in which an optical anisotropic layer is formed on the transparent substrate; a retardation layer forming step of forming, on a surface opposite to the optical-anisotropic-layer-formed surface of the optical anisotropic film formed in the optical anisotropic film forming step, a retardation layer containing a liquid crystalline material, in which a relation of nx≦ny<nz is realized between refractive indexes “nx” and “ny” in arbitrary directions “x” and “y” of an in-plane direction which are perpendicular to each other and a refractive index “nz” in a thickness direction, and thereby forming an optical laminate in which the retardation layer is formed on the optical anisotropic layer; and a stretching step of stretching the optical laminate formed in the retardation layer forming step.

According to the invention, as the above-mentioned transparent substrate, a substrate comprising a cellulose derivative is used, thereby making the following possible: when the retardation film produced by the invention is used as, for example, an inside polarizing plate protective film, a polarizing plate protective film comprising a cycloolefin rein is used as the corresponding outside polarizing plate protective film. As a result, a polarizing plate very good in durability can be yielded.

Moreover, according to the invention, the retardation layer forming step is a step for forming a retardation layer on the surface opposite to the optical-anisotropic-layer-formed surface of the optical anisotropic film, thereby rendering this retardation layer easily a retardation layer very good in the performance of expressing retardation property.

From such matters, a retardation film capable of producing a polarizing plate excellent in durability can be produced according to the invention.

In the invention, the solvent preferably contains a ketone solvent having a boiling point of 100° C. or higher. This makes it possible to form an optical anisotropic film small in haze in the optical anisotropic film forming step, thus, according to the invention, a retardation film very good in transparency can be produced by the invention.

In the invention, the ketone solvent is preferably cyclopentanone or cyclohexanone. When cyclopentanone or cyclohexanone is used as the ketone solvent, an optical anisotropic film smaller in haze can be formed in the optical anisotropic film forming step. As a result, according to the invention, a retardation film better in transparency can be produced by the invention.

In the invention, the cellulose derivative is preferably triacetylcellulose. Since triacetylcellulose is very good in optical isotropy, the use of triacetylcellulose makes it possible to produce a retardation film good in optical characteristics.

The invention provides a liquid crystal display wherein the retardation film of the invention, which has been described above, is used. According to the invention, the retardation film of the invention is used, thereby making it possible to yield a liquid crystal display very good in durability and viewing angle property.

The invention also provides a liquid crystal display wherein the brightness enhancement film of the invention, which has been described above, is used. According to the invention, the brightness enhancement film of the invention is used, thereby making it possible to yield a liquid crystal display very good in brightness property.

The invention also provides a liquid crystal display wherein the polarizing plate of the invention, which has been described above, is used. According to the invention, the polarizing plate of the invention is used, thereby making it possible to yield a liquid crystal display very good in durability and viewing angle property.

The invention also provides a liquid crystal display wherein a retardation film produced by the retardation film producing method of the invention, which has been described above, is used. According to the invention, the retardation film produced by the retardation film producing method of the invention is used, thereby making it possible to yield a liquid crystal display very good in durability and viewing angle property.

### ADVANTAGEOUS EFFECT OF THE INVENTION

The retardation film of the invention produces an advantageous effect that the use of the film as a polarizing plate protective film makes it possible to yield a polarizing plate that is very good in durability and further has a viewing angle compensation function.

### BRIEF DESCRIPTION OF THE DRAWINGS

FIG. 1 is a schematic view illustrating an example of the retardation film of the invention.

FIGS. 2A and 2B are schematic views illustrating another example of the retardation film of the invention.

FIGS. 3A and 3B are schematic views illustrating another example of the retardation film of the invention.

FIG. 4 is a schematic view illustrating an example of the brightness enhancement film of the invention.

FIG. 5 is a schematic view illustrating an example of the polarizing plate of the invention.

FIG. 6 is a schematic view illustrating another example of the polarizing plate of the invention.

FIGS. 7A to 7E are schematic views illustrating an example of the producing method of a retardation film according to a first embodiment of the invention.

FIGS. 8A to 8E are schematic views illustrating an example of the producing method of a retardation film according to a second embodiment of the invention.

FIGS. 9A to 9E are schematic views illustrating an example of the producing method of a retardation film according to a third embodiment of the invention.

FIGS. 10A to 10E are schematic views illustrating an example of the producing method of a retardation film according to a fourth embodiment of the invention.

FIG. 11 is a schematic view illustrating an example of the liquid crystal display according to a first embodiment of the invention.

FIG. 12 is a schematic view illustrating an example of the liquid crystal display according to a second embodiment of the invention.

FIG. 13 is a schematic view illustrating an example of the liquid crystal display according to a third embodiment of the invention.

FIG. 14 is a schematic view illustrating an example of the liquid crystal display according to a fourth embodiment of the invention.

FIG. 15 is a schematic view which schematically illustrates a part of an ordinary liquid crystal display.

FIG. 16 is a schematic view which schematically illustrates a part of a liquid crystal display wherein a retardation film is used.

FIGS. 17A and 17B are each a schematic view illustrating an example of the use embodiment of a retardation film.

### DESCRIPTION OF REFERENCES NUMERALS

1, 1A, and 1A′: optical anisotropic film
1a, and 51a: transparent substrate
1b, 1b′, and 51b: optical anisotropic layer
2, and 52: retardation layer
10, 10′, 10″, and 50: retardation film
11: liquid crystal cell
20: brightness enhancement film
21: cholesteric liquid crystal layer
30, and 40: polarizing plate
31, and 41: polarizer
32, and 42: polarizing plate protective film
50′: optical laminate
60, 70, 80, and 90: liquid crystal display
101: liquid crystal cell
102A, 102B, 102A′, and 102B′: polarizing plate
103: retardation film
111: polarizer
112, 112a, and 112b: polarizing plate protective film

### BEST MODE FOR CARRYING OUT THE INVENTION

Hereinafter, the retardation film, the brightness enhancement film, the polarizing plate, the producing method of a retardation film, and the liquid crystal display of the invention will be described in turn.

A. Retardation Film

First, a retardation film of the present invention will be explained. The retardation film of the present invention comprises: an optical anisotropic film, in which a relation of nx>ny is realized between a refractive index “nx” in a slow axis direction of an in-plane direction and a refractive index “ny” in a fast axis direction of the in-plane direction; and a retardation layer formed on the optical anisotropic film and containing a liquid crystalline material, in which a relation of nx≦ny<nz is realized between refractive indexes “nx” and “ny” in arbitrary directions “x” and “y” of an in-plane direction which are perpendicular to each other and a refractive index “nz” in a thickness direction, characterized in that the optical anisotropic film uses a transparent substrate comprising a cellulose derivative.

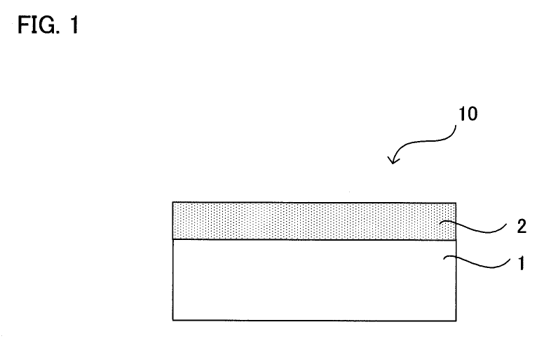

With reference to the drawings, the retardation film of the invention is described. FIG. 1 is a schematic view illustrating an example of the retardation film of the invention. As illustrated in FIG. 1, a retardation film 10 of the invention has an optical anisotropic film 1, and a retardation layer 2 formed on the optical anisotropic film 1 and containing a liquid crystalline material. About the optical anisotropic film 1, between the refractive index “nx” in the slow axis direction of the in-plane direction and the refractive index “ny” in the fast axis direction of the in-plane direction, the relation of nx>ny is realized. Moreover, about the retardation layer 2, between the refractive indexes “nx” and “ny” in arbitrary directions “x” and “y” of the in-plane direction which are perpendicular to each other and the refractive index “nz” in the thickness direction, the relation of nx≦ny<nz is realized.

In such an example, the retardation film 10 of the invention is a film wherein a transparent substrate made of a cellulose derivative is used in the optical anisotropic film 1.

According to the invention, a transparent substrate made of a cellulose derivative is used as the above-mentioned optical anisotropic film, thereby making the following possible: when the retardation film of the invention is used as an inside polarizing plate protective film, a polarizing plate protective film made of a cycloolefin rein is used as the corresponding outside polarizing plate protective film. As a result, a polarizing plate very good in durability can be yielded.

Moreover, according to the invention, the retardation layer satisfies the relation of nx≦ny<nz and further the optical anisotropic film satisfies the relation of nx>ny, therefore, when the retardation film of the invention is used as a polarizing plate protective film, a polarizing plate having a viewing angle compensation function for an IPS mode liquid crystal display can be yielded.

From such matters, when the invention is used as a polarizing plate protective film, a retardation film can be yielded which is capable of yielding a polarizing plate that is very good in durability and further has a viewing angle compensation function.

The retardation film of the invention is a film having at least the above-mentioned optical anisotropic film and a retardation layer.

Hereinafter, each of the constituents used in the retardation film of the invention will be described in detail.

1. Optical Anisotropic Film

First, the optical anisotropic film used in the invention is described. The optical anisotropic film used in the invention is a film wherein between the refractive index “nx” in the slow axis direction of the in-plane direction and the refractive index “ny” in the fast axis direction of the in-plane direction, the relation of nx>ny is realized, and further a transparent substrate made of a cellulose derivative is used.

The relation between the refractive index “nx” in the slow axis direction of the in-plane direction, the refractive index “ny” in the fast axis direction of the in-plane direction, and the refractive index “nz” in the thickness direction in the optical anisotropic film used in the invention is not particularly limited as far as the relation satisfies the relation of nx>ny. Examples of the embodiment wherein the relation of nx>ny is realized in the optical anisotropic film of the invention include embodiments wherein the relation of nx>ny>nz is realized, that of nx>nz>ny is realized, that of nx>ny=nz is realized, and that of nz>nx>ny is realized. The optical anisotropic film used preferably in the invention is an optical anisotropic film wherein any one of these relations is realized.

About the optical anisotropic film used in the invention, the relation of nx>ny (that is, Re>0), out of relations between “nx”, “ny” and “nz”, is exclusively used in some cases. The “nz” value (that is, the absolute value of the Rth and the sign thereof (Rth>0 or Rth<0)) is appropriately adjusted, considering desired viewing angle compensation property and other optical characteristics. The retardation film is required to satisfy Rth<0 (the so-called +C plate property) as a whole, and further the retardation layer satisfies: Rth<0. Therefore, if the optical anisotropic film also satisfies: Rth<0, the absolute value of the Rth of the retardation layer itself is set to a value smaller than a desired value based on the retardation film. On the other hand, if the optical anisotropic film also satisfies: Rth>0, the absolute value of the Rth of the retardation layer itself is set to a value larger than a desired value based on the retardation film.

When the optical anisotropic film used in the invention is an embodiment wherein the relation of nx>ny=nz is realized, it is preferable that the retardation (Re) of the optical anisotropic film at a wavelength of 550 nm, which is represented by “Re₅₅₀”, satisfies: 0 nm<Re₅₅₀<300 nm.

It is also preferable that the thickness direction retardation (Rth) at a wavelength of 550 nm ranges from 0 to 300 nm.

When the retardation (Re), and the retardation (Rth) in the thickness direction are in the above-mentioned ranges, the retardation film of the invention can be rendered a film suitable as a viewing angle compensation film of a liquid crystal display.

In the meantime, when the optical anisotropic film used in the invention is a film wherein the relation of nx>ny>nz or nx>nz>ny is realized, the retardation (Re) of the optical anisotropic film at a wavelength of 550 nm preferably satisfies: 0 nm<Re₅₅₀<300 nm.

The retardation in the thickness direction (Rth) at a wavelength of 550 nm preferably ranges from −300 to 300 nm. When the retardation (Re), and the retardation (Rth) in the thickness direction are in the above-mentioned ranges, the retardation film of the invention can be rendered a film suitable as a viewing angle compensation film of a liquid crystal display.

Using “nx” and “ny”, which have been described above, and the thickness d of the film, the retardation, which may be referred to merely as the “Re” hereinafter, is represented by Re=(nx−ny)×d.

Using “nx”, “ny”, “nz” and “d”, which have been described above, the retardation in the thickness direction, which may be referred to merely as the “Rth” hereinafter, is represented by Rth={(nx+ny)/2−nz}×d.

The Re and Rth can be measured by, for example, a parallel Nicol rotation method using a KOBRA-WR manufactured by Oji Scientific Instruments.

The wavelength dependency of the Re of the optical anisotropic film used in the invention may be of a reverse dispersion type, a normal dispersion type or a flat dispersion type.

In the invention, the wavelength dependency of the Re may be referred to as the “wavelength dispersion”.

In general, the type of a wavelength dispersion wherein the Re becomes smaller at wavelengths from large values toward smaller values (that is, the Re is an increasing function of wavelength) is called the “reverse dispersion type”. In the invention, however, a “reverse dispersion type” means that the ratio of the Re at a wavelength of 450 nm (Re₄₅₀) to the Re at a wavelength of 550 nm (Re₅₅₀) (Re₄₅₀/Re₅₅₀), which may be referred to merely as the “Re ratio” hereinafter, is smaller than 1.

In general, the type of a wavelength dispersion wherein the Re becomes larger at wavelengths from large values toward smaller values (that is, the Re is a decreasing function of wavelength) is called the “normal dispersion type”. In the invention, however, a “normal dispersion type” means that the Re ratio is larger than 1.

Furthermore, in general, the type of a wavelength dispersion wherein the Re does not have any wavelength dependency is called the “flat type”. In the invention, however, a “flat type” means that the Re ratio is 1.

The optical anisotropic film used in the invention may be usually an optical anisotropic film exhibiting a wavelength dependency of a reverse dispersion type or of a normal dispersion type. Thus, an embodiment wherein the wavelength dependency is of a reverse dispersion type is referred to as a “first embodiment”, and an embodiment wherein the wavelength dependency is of a normal dispersion type is referred to as a “second embodiment”, and the optical anisotropic films of the individual embodiments will be described in turn.

### 1-1. First Embodiment

First, the optical anisotropic film of the first embodiment used in the invention is described. The optical anisotropic film of the present embodiment is an embodiment having a Re exhibiting a wavelength dependency of a reverse dispersion type.

The optical anisotropic film of the embodiment can be preferably used, for example, when a retardation layer having a Re exhibiting a wavelength dependency of a reverse dispersion type is used as the retardation layer which will be described later.

The optical anisotropic film of the embodiment is not particularly limited as far as the Re ratio thereof is smaller than 1. It is advisable to adjust the Re appropriately in accordance with the usage of the retardation film of the invention, or some other factor. In particular, in the embodiment, the Re ratio is preferably from 0.6 to 0.99, in particular preferably from 0.7 to 0.95. When the Re ratio is in the range, the retardation film of the invention can be rendered a film capable of improving the viewing angle property of a liquid crystal display in a wider wavelength range.

The optical anisotropic film of the embodiment is a film wherein a transparent substrate made of a cellulose derivative is used. The cellulose derivative, which constitutes the transparent substrate, is not particularly limited as far as the derivative is a cellulose derivative that has a desired water permeability, and makes the following possible: when the retardation film of the invention is used as a polarizing plate protective film, water contained in a polarizer in a polarizing plate producing step permeates the derivative so that a fall in the polarization property with time is restrained to a desired degree. In particular, the cellulose derivative used in the embodiment is preferably any one of cellulose esters. Out of cellulose esters, cellulose acylates are preferred. Since cellulose acylates are widely used in industries, the use thereof is advantageous from the viewpoint of easy availability.

A lower aliphatic acid ester having 2 to 4 carbon atoms is preferable as one of the above-mentioned cellulose acylates. The lower aliphatic acid ester may be an ester containing a single lower aliphatic acid ester, such as cellulose acetate, or an ester containing plural aliphatic acid esters, such as cellulose acetate butyrate or cellulose acetate propionate.

In the embodiment, a cellulose acetate can be in particular preferably used out of lower aliphatic acid esters as described above. The cellulose acetate is most preferably triacetyl cellulose having an average acetification degree of 57.5 to 62.5% (substitution degree: 2.6 to 3.0). Since triacetyl cellulose has a molecular structure having relatively bulky sides, the use of the transparent substrate made of such a triacetyl cellulose makes it possible to improve the adhesion property between the transparent substrate and the optical anisotropic layer.

The acetification degree means the amount of acetic acid bonded to a cellulose per unit mass thereof. The acetification degree may be obtained by the measurement and calculation of acetylation degree in accordance with ASTM: D-817-91 (Method for Testing Cellulose Acetate or the Like). The acetification degree of the triacetyl cellulose which constitutes a triacetyl cellulose film may be obtained by the above-mentioned method after impurities contained in the film, such as a plasticizer, are removed.

The mode wherein the above-mentioned transparent substrate is used in the optical anisotropic film of the present embodiment is not particularly limited as far as the mode is a mode in which a desired optical anisotropy, a desired wavelength dependency of the Re, and desired other properties can be given to the optical anisotropic film of the embodiment. Examples of this mode include a mode in which the optical anisotropic film of the embodiment is made only of the transparent substrate, and a mode in which an optical anisotropic layer is laminated on the transparent substrate. The optical anisotropic film of the embodiment may be made into any one of these modes. In particular, the latter mode is preferable. This makes it easy to give a desired function to the optical anisotropic film of the embodiment with a high freedom degree but without producing any effect onto various properties of the transparent substrate itself, such as the strength thereof, nor conditions for the production.

The optical anisotropic film of the embodiment that is in the mode in which an optical anisotropic layer is formed on the transparent substrate is not particularly limited as far as a desired function can be given to the retardation film of the invention. Examples of this mode include a mode in which an optical anisotropic film has the transparent substrate, and an optical anisotropic layer formed on the transparent substrate and containing a urethane resin (the optical anisotropic film in a first mode); and a mode in which an optical anisotropic film has the transparent substrate, and an optical anisotropic layer formed on the transparent substrate and containing not only the cellulose derivative which constitutes the transparent substrate but also an optical anisotropic material having a retardation exhibiting a wavelength dependency of a normal dispersion type (the optical anisotropic film in a second mode).

About each of these modes, the optical anisotropy of nx>ny can be given thereto by forming the optical anisotropic layer onto the transparent substrate, and then keeping the resultant as it is or optionally subjecting the resultant to stretching treatment.

The following will describe the optical anisotropic films in the individual modes in turn.

(1) The Optical Anisotropic Film in the First Mode

First, the optical anisotropic film in the first mode is described. The optical anisotropic film in the mode is a mode in which an optical anisotropic film has the transparent substrate, and an optical anisotropic layer formed on the transparent substrate and containing a urethane resin.

The urethane resin has urethane bond moieties (—O—CO—N<) having a Re exhibiting a wavelength dependency of a reverse dispersion type, therefore, the urethane resin has an advantage that when the resin is used, the optical anisotropic film in the mode can easily be made so as to have a Re exhibiting a wavelength dependency of a reverse dispersion type.

Hereinafter, the optical anisotropic film in the mode will be described in detail.

a. Optical Anisotropic Layer

The urethane resin used in the mode is not particularly limited as far as the resin is a urethane resin having a refractive index anisotropy to such an extent that a desired retardation property can be given to the optical anisotropic layer.

About the urethane resin used in the mode, the Re ratio is preferably 0.6 or more and less than 1.0, in particular preferably from 0.7 to 0.95, more preferably from 0.8 to 0.9.

The Re ratio of the urethane resin may be calculated out by forming a film made of the urethane resin, which is a target to be evaluated, onto an optical isotropic substrate such as a glass substrate, peeling the film from the optical isotropic substrate, further subjecting the resultant to stretching treatment to yield a sample, and then measuring the retardation of the sample at a wavelength of 450 nm (Re₄₅₀) and the retardation thereof at a wavelength of 550 nm (Re₅₅₀). The retardations may be measured by, for example, a parallel Nicol rotation method using a KOBRA-WR manufactured by Oji Scientific Instruments.

The “refractive index anisotropy” means that the refractive index to incident light is varied in accordance with the incident direction of the light.

About the urethane resin used in the mode, the complex tensile elastic modulus thereof at 30° C. is preferably 800 MPa or less, more preferably from 1 to 800 MPa, in particular preferably from 10 to 600 MPa. When the complex tensile elastic modulus is in such a range, produced is, for example, an advantage that in the step of producing the optical anisotropic film in the mode, the optical anisotropic layer thereof is easily stretched.

The complex tensile elastic modulus (E*) is represented by the following equation, using the storage tensile elastic modulus (E″) and the loss tensile elastic modulus (E′):

E*=√((E′)²+(E″)²)

The complex elastic modulus (E*) can be obtained in accordance with the equation by measuring the storage tensile elastic modulus (E″) and the loss tensile elastic modulus (E′) under conditions described below with a “Rheogel-E4000” manufactured by UBM Co., Ltd.

Distance between chucks: 15 mm

Sample width: 5 mm

Strain: 100 μm

Temperature-raising rate: 3° C./min

Frequency: 10 Hz

The urethane resin used in the present mode, as described above, is not particularly limited as far as the resin is a resin having, in the molecule thereof, a urethane bond moiety (—O—CO—N<). Thus, any urethane resin may be used in accordance with the usage or the producing method of the retardation film of the invention, or some other factor. Examples of the urethane resin used in the mode include polyurethane and urethane acrylate. In the mode, it is particularly preferable to use urethane acrylate as the urethane resin. Urethane acrylate has an advantage that when, for example, an atomic group having refractive index anisotropy is bonded to its urethane bond moieties across these moieties so as to modify the acrylate, the acrylate can control the property of expressing retardation property at will, and other advantages.

The urethane acrylate is not particularly limited as far as it is a compound obtained by polymerizing a urethane acrylate monomer having a urethane bond moiety and an acryloyl group.

The urethane acrylate monomer may contain the single acryloyl group, or may contain plural acryloyl group.

The urethane acrylate monomer may contain the single urethane bond moiety, or may be contain plural urethane bond moieties.

The urethane acrylate used in the mode is preferably a product obtained by polymerizing a urethane acrylate monomer having, between its urethane bond moiety and its acryloyl group, an atomic group having refractive index anisotropy. When the urethane acrylate obtained by polymerizing the urethane acrylate monomer is stretched, the acrylate can cause its atomic groups, which have refractive index anisotropy, to be aligned into a single direction, thus, the acrylate is very good in the performance of expressing retardation property.

About the urethane acrylate monomer, which has an atomic group having refractive index anisotropy, the total of the atomic weights of elements constituting the atomic group present between the urethane bond moiety and the acryloyl group is preferably from 100 to 1000, more preferably from 200 to 600, in particular preferably from 400 to 600. If the total of the atomic weights is smaller than the range, the number of the atomic groups which contribute to the expression of retardation property becomes small so that a desired retardation property may not be given, with ease, to the optical anisotropic layer in the mode. If the total of the atomic weights is more than the range, the number of urethane bond moieties present in the urethane acrylate obtained by polymerizing the urethane acrylate monomer becomes small so that the Re ratio of the optical anisotropic film in the mode may not be easily controlled into a desired degree.

The kind of the atomic group having refractive index anisotropy is not particularly limited as far as the atomic group is an atomic group permitting a desired retardation property to be given to the retardation film of the invention in accordance with the usage of the retardation film of the invention, the producing method thereof, or some other factor. Examples of the atomic group having refractive index anisotropy include ester atomic groups each having an ester bond, and ether atomic groups each having an ether group. In the mode, any one of these atomic groups can be preferably used. It is particularly preferable to use an ester atomic group. The use of the ester atomic group makes it possible to render the urethane acrylate a urethane acrylate better in the performance of expressing retardation property. Moreover, the urethane acrylate monomer having this ester atomic group can be relatively easily synthesized, so that the retardation film of the invention can be rendered a film very good in production-suitability.

Examples of the ester atomic group include lactone atomic groups each having a constituting unit of a lactone, polycarbonate atomic groups each having a constituting unit of a polycarbonate, and adipate atomic groups each having a constituting unit of an adipate. In the mode, any one of these atomic groups can be preferably used. It is particularly preferable to use a lactone atomic group. The lactone atomic group is high in refractive index anisotropy and is very good in the performance of expressing retardation property.

In the mode, it is preferable to use, out of lactone atomic groups, a caprolactone modified atomic group containing a constituting unit of caprolactone. Since the caprolactone modified atomic group is larger in refractive index anisotropy, the retardation-expressing performance of the resin material can be further improved.

The caprolactone modified atomic group may contain a single constituting unit of caprolactone, or may contain plural constituting units of caprolactone.

When the caprolactone modified atomic group contains plural constituting units of caprolactone, the number of the constituting units of caprolactone contained in the caprolactone modified atomic group is preferably from 2 to 5.

The urethane acrylate used in the invention may be a compound obtained by polymerizing a single urethane acrylate monomer, or may be a compound obtained by polymerizing plural urethane acrylate monomers.

The optical anisotropic layer in the mode may contain a compound other than the urethane resin. The other compound is not particularly limited as far as the compound is a compound which does not damage the retardation property given to the optical anisotropic layer, or the wavelength dependency of the Re. Thus, any compound may be used in accordance with the usage of the retardation film of the invention, or some other factor.

The other compound is, for example, a compound having refractive index anisotropy, which contributes to the retardation-property-expressing performance of the optical anisotropic layer. The use of the compound makes it possible to increase the retardation property, for example, when a desired retardation property is not easily given to the optical anisotropic layer only by action of the urethane resin. Examples of the compound, which has refractive index anisotropy, include liquid crystal compounds, and inorganic compounds having refractive index anisotropy.

In the case of using the above-mentioned urethane acrylate as the urethane resin contained in the optical anisotropic layer in the mode, it is preferable to use a photopolymerization initiator as the other compound. As the photopolymerization initiating agent used in the mode, for example, benzophenone, o-benzoyl methyl benzoate, 4,4-bis(dimethyl amine) benzophenone, 4,4-bis(diethyl amine) benzophenone, α-amino-acetophenone, 4,4-dichlorobenzophenone, 4-benzoyl-4-methyl diphenyl ketone, dibenzyl ketone, fluolenone, 2,2-diethoxyacetophenone, 2,2-dimethoxy-2-phenyl acetophenone, 2-hydroxy-2-methyl propiophenone, p-tert-butyl dichloroacetophenone, thioxantone, 2-methyl thioxantone, 2-chlorothioxantone, 2-isopropyl thioxantone, diethyl thioxantone, benzyldimethyl ketal, benzyl methoxy ethyl acetal, benzoin methyl ether, benzoin butyl ether, anthraquinone, 2-tert-butyl anthraquinone, 2-amyl anthraquinone, β-chloranthraquinone, anthrone, benzanthrone, dibenzsuberone, methylene anthrone, 4-adidobenzyl acetophenone, 2,6-bis (p-adidobendilidene)cyclohexane, 2,6-bis (p-adidobendilidene)-4-methyl cyclohexanone, 2-phenyl-1,2-butadion-2-(o-methoxy carbonyl)oxime, 1-phenyl-propane dion-2-(o-ethoxy carbonyl)oxime, 1,3-diphenyl-propane trion-2-(o-ethoxy carbonyl)oxime, 1-phenyl 3-ethoxy-propane trion-2-(o-benzoyl)oxime, Michler's ketone, 2-methyl-1[4-(methyl thio)phenyl]-2-morpholino propane-1-on, 2-benzyl-2-dimethyl amino-1-(4-morpholino phenyl)-butanone, naphthalene sulfonyl chloride, quinoline sulfonyl chloride, n-phenyl thioacrydone, 4,4-azo bis isobuthylonitrile, diphenyl disulfide, benzthiazol disulfide, triphenyl phosphine, camphor quinine, N1717 produced by Asahi Denka Co., Ltd., carbon tetrabromate, tribromo phenyl sulfone, benzoin peroxide, eosin, or a combination of a photo reducing pigment such as a methylene blue and a reducing agent such as ascorbic acid and triethanol amine can be presented. In the present embodiment, these photo polymerization initiating agents can be used only by one kind or as a combination of two or more kinds.

Furthermore, in the case of using the photo polymerization initiating agent, a photo polymerization initiating auxiliary agent can be used in combination. As such a photo polymerization initiating auxiliary agent, tertiary amines such as triethanol amine, and methyl diethanol amine; benzoic acid derivatives such as 2-dimethyl aminoethyl benzoic acid and 4-dimethyl amide ethyl benzoate can be presented, however, it is not limited thereto.

The thickness of the optical anisotropic layer used in the mode is not particularly limited as far as the thickness permits a desired retardation property to be given to the retardation film of the invention in accordance with the kind of the urethane resin. Usually, the thickness of the optical anisotropic layer in the mode is preferably from 0.5 to 20 μm.

b. Transparent Substrate

Next, the transparent substrate used in the mode is described. The transparent substrate used in the mode is a transparent substrate made of the above-mentioned cellulose derivative.

The transparency of the transparent substrate used in the mode may be determined optionally according to factors such as the transparency required to the retardation film of the present invention. In general, it is preferable that the transmittance in a visible light zone is 80% or more, and it is more preferably 90% or more.

Here, the transmittance of the transparent substrate can be measured according to the JIS K7361-1 (Testing method of the total light transmittance of a plastic-transparent material).

The thickness of the transparent substrate used in the mode is not particularly limited as long as necessary self supporting properties can be obtained according to factors such as the application of the retardation film of the present invention. In general, it is preferably in the range of 10 μm to 188 μm; it is more preferably in the range of 20 μm to 125 μm; and it is particularly preferably in the range of 30 μm to 80 μm.

In the case the thickness of the transparent substrate is thinner than the above-mentioned range, the necessary self supporting properties may not be provided to the retardation film of the present invention. Moreover, in the case the thickness is thicker than the above-mentioned range, for example, at the time of cutting process of the retardation film of the present invention, the process waste may be increased or wear of the cutting blade may be promoted.

The Re of the transparent substrate used in the mode is not particularly limited as far as the Re permits a desired retardation property to be given to the retardation film of the invention. The Re may be adjusted at will in accordance with the usage of the retardation film of the invention or a specific form of the optical anisotropic film used in the mode. About the transparent substrate used in the mode, the Re at 550 nm is preferably from 0 to 50 nm.

About the transparent substrate used in the mode, the Rth at a wavelength of 550 nm is preferably from 0 to 100 nm.

The wavelength dependency of the Re of the transparent substrate used in the mode may be of a reverse dispersion type, a normal dispersion type or a flat dispersion type. In the mode, the wavelength dependency is preferably of a reverse dispersion type.

When the wavelength dependency of the Re of the transparent substrate is of a reverse dispersion type, the retardation film of the invention can be rendered a film capable of expressing a viewing angle compensation function for a liquid crystal display in a wider wavelength range.

About the transparent substrate used in the mode, it is preferable that the value represented by (the storage tensile elastic modulus)×(the cross-section area) is larger than the value of the optical anisotropic layer and further the dimension shrinkage ratio thereof is smaller than that of the optical anisotropic layer. The use of the transparent substrate having this feature makes it possible to prevent more effectively the generation of a change in dimension of the optical anisotropic layer with the passage of time so as to yield a retardation film very good in stability of optical characteristics over time.

The value represented by (the storage tensile elastic modulus of the transparent substrate used in the mode)×(the cross-section area thereof) can be appropriately adjusted into a preferable range in accordance with the kind of the urethane resin and the others contained in the optical anisotropic layer, the usage of the retardation film of the invention, or some other factor. The value represented by (the storage tensile elastic modulus of the transparent substrate used in the mode)×(the cross-section area thereof) is preferably 10 or more times the value represented by (the storage tensile elastic modulus of the optical anisotropic layer)×(the cross-section area thereof), in particular preferably 20 or more times the value, more preferably 35 or more times the value. When the value represented by (the storage tensile elastic modulus of the transparent substrate)×(the cross-section area thereof) is in the range, the dimension stability of the optical anisotropic film in the mode can be further controlled or dominated by mechanical properties of the transparent substrate, therefore, mechanical properties of the whole of the optical anisotropic film can be controlled by controlling, for example, the mechanical properties of the transparent substrate. As a result, produced is an advantage that it becomes easy to design the stability over time of optical characteristics of the optical anisotropic film in the mode.

The value represented by (the storage tensile elastic modulus of the transparent substrate used in the mode)×(the cross-section area thereof) is specifically set into the range of about 10000 to 5000000 N, more preferably the range of about 10000 to 1000000 N, even more preferably the range of about 50000 to 500000 N.

The value, which is represented by (the storage tensile elastic modulus)×(the cross-section area), can be obtained by using, for example, a “Rheogel-E400” manufactured by UBM Co., Ltd. to measure the storage tensile elastic modulus under conditions described below, and then multiplying the measured value by the cross-section area of the transparent substrate.

Distance between chucks: 15 mm

Sample width: 5 mm

Strain: 100 μm

Temperature-raising rate: 3° C./min

Frequency: 10 Hz

When the optical anisotropic layer penetrates the transparent substrate in the optical anisotropic film in the mode or some other phenomenon is caused so that the storage tensile elastic modulus of the transparent substrate alone is not easily measured by the above-mentioned method, the following relation may be used: a generally-known relation between dynamic elastic modulus in a press direction and dynamic elastic modulus in the corresponding shear direction, that is, [(the elastic modulus in the shear direction)=(the elastic modulus in the press direction)/3]. In other words, when the storage tensile elastic modulus of the transparent substrate alone is not easily measured, the compression elastic modulus may be used instead of the storage tensile elastic modulus.

When the compression elastic modulus is used instead of the storage tensile elastic modulus, the value represented by (the compression elastic modulus of the transparent substrate)×(the cross-section area thereof) is not particularly limited as far as the value is larger than the value represented by (the compression elastic modulus of the optical anisotropic layer)×(the cross-section area thereof). The value represented by (the compression elastic modulus of the transparent substrate in the mode)×(the cross-section area thereof) is preferably from 30000 to 15000000 N, in particular preferably from 30000 to 3000000 N, more preferably from 150000 to 1500000 N when the width of the transparent substrate is 1 m and the coating width of the optical anisotropic layer is 1 m.

The compression elastic modulus used herein is a value measured by use of an ENT-1100a manufactured by Elionix Co., Ltd. under the following conditions:

Measurement depth: 500 nm

Measurement: division is made at 500 points, and the step interval per point is set to 10 msec.

The “cross-section area” means the cross-section area of a cross section in a direction perpendicular to the direction parallel to the transparent substrate [(the thickness of the transparent substrate)×(the width of the transparent substrate)].

The dimension shrinkage ratio of the transparent substrate used in the mode is not particularly limited as far as the ratio is smaller than that of the optical anisotropic layer. The dimension shrinkage ratio of the transparent substrate used in the mode is preferably from 0.01 to 1%, in particular preferably from 0.01 to 0.1%, more preferably from 0.01 to 0.02%.

The value represented by the dimension shrinkage ratio can be obtained from an equation described below, for example, by measuring the length La of the transparent substrate stretched into a length 1.4 times the original length of the substrate and the length Lb of the substrate after a lapse of one day from the stretching.

Dimension shrinkage ratio=(La−Lb)/La

Furthermore, the transparent substrate used in the mode is preferably a substrate very good in dimension stability in a high-temperature and high-humidity atmosphere. In the case of using, as the transparent substrate, a substrate very good in dimension stability in a high-temperature and high-humidity atmosphere, the dimension stability of the whole of the retardation film can be improved in a high-temperature and high-humidity atmosphere, so that the obtained retardation film can be good in stability of optical characteristics in a high-temperature and high-humidity atmosphere also. About the transparent substrate used in the mode, the dimension change ratio thereof is preferably 25% or less, in particular preferably from 0.1 to 10%, more preferably from 0.1 to 5% when the substrate is kept into an environment 90° C. in temperature and 90% RH in relative humidity for 1 hour.

The structure of the transparent substrate used in the mode is not limited to a structure made of a single layer, and the transparent substrate may have a structure wherein plural layers are laminated onto each other.

When the transparent substrate has a structure wherein plural layers are laminated onto each other, the layers which have the same composition may be laminated or the layers which have different compositions may be laminated.

c. Others

The optical anisotropic film in the mode is a film having a structure wherein the above-mentioned optical anisotropic layer is formed on the above-mentioned transparent substrate so as to cause the two members to adhere closely to each other. In this case, the degree of the close adhesion between the optical anisotropic layer and the transparent substrate is not particularly limited as far as mechanical properties of the optical anisotropic layer can be controlled through mechanical properties of the transparent substrate. About the degree of the close adhesion in the invention, the evaluation result of a cross-cut method ranges preferably from 20/100 to 100/100.

The “cross-cut method” is an evaluating method in accordance with “Ordinary Testing Methods for Coatings—Part 5: Mechanical Property of Film—Chapter 6: Adhesion (Cross-cut method)” in Japanese Industrial Standard JISK 5600-5-6, and is a method of making a cut on a coated surface to give 1-mm squares in a grid form, causing an adhesive tape (CELLOTAPE (registered trade mark), manufactured by Nichiban Co., Ltd.) to adhere thereon, peeling out the tape, and counting remaining ones out of 100 squares of the 1-mm squares, thereby evaluating the adhesion.

Any evaluation result of the cross-cut method represents the number of remaining ones out of the 100 evaluating regions in the grid form. For example, the above-mentioned “20/100” means that the number of remaining ones out of the 100 evaluating regions is 20, and the “100/100” means that out of the 100 evaluating regions, all of the 100 regions remain without being peeled off.

In the optical anisotropic film in the mode, the form that the transparent substrate and the optical anisotropic layer are laminated onto each other may be a form that the transparent substrate and the optical anisotropic layer are laminated in the state that the substrate and the layer are independent layers, or a form that a define interface is not present between the transparent substrate and the optical anisotropic layer and the two members are laminated in such a manner that the content of the above-mentioned urethane resin is continuously changed between the two.

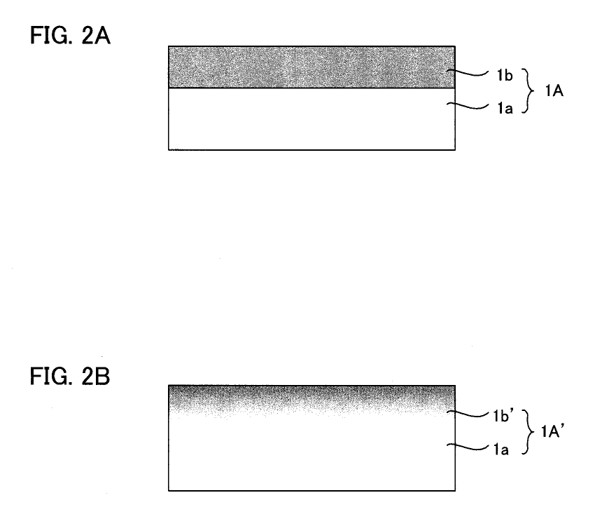

With reference to some of the drawings, such forms that the transparent substrate and the optical anisotropic layer are laminated are described. FIGS. 2A and 2B are each a schematic view illustrating an example of a form that the transparent substrate and the optical anisotropic layer are laminated in the optical anisotropic film in the mode. As illustrated in FIGS. 2A and 2B, an optical anisotropic film 1A or 1A′ in the mode may be a form that a transparent substrate 1a and an optical anisotropic layer 1b which are layers independent of each other are laminated onto each other (FIG. 2A), or a form that a define interface is not present between a transparent substrate 1a and an optical anisotropic layer 1b′ and the two members are laminated in such a manner that the content of the above-mentioned urethane resin is continuously changed between the two (FIG. 2B).

(2) Optical Anisotropic Film in the Second Mode

Next, the optical anisotropic film in the second mode is described. The optical anisotropic film in the mode has a transparent substrate made of a cellulose derivative, and an optical anisotropic layer formed on the transparent substrate and containing not only the cellulose derivative which constitutes the transparent substrate but also an optical anisotropic material having a retardation exhibiting a wavelength dependency of a normal dispersion type.

The optical anisotropic film in the mode has an advantage that the optical anisotropic film can easily be rendered a film having a retardation the wavelength dependency of which exhibits reverse dispersibility, for example, by using, as the transparent substrate, a substrate having a Re exhibiting a wavelength dependency of a reverse dispersion type and making the absolute value of the Re ratio of the transparent substrate larger than that of the Re ratio of the optical anisotropic layer.

Hereinafter, the optical anisotropic film in the mode will be described in detail.

a. Optical Anisotropic Layer

First, the optical anisotropic material used in the mode is described. The optical anisotropic material used in the mode is not particularly limited as far as the material is a material having a retardation exhibiting a wavelength dependency of a normal dispersion type. The material that can be used may be appropriately selected from materials capable of giving a desired retardation property to the retardation film of the invention in accordance with the usage of the retardation film of the invention, or some other factor. The optical anisotropic material used in the mode is preferably a material wherein the Re ratio is from 1 to 2. In order to make use of the reverse dispersion property of the transparent substrate, it is particularly preferable to use a material wherein the Re ratio is as close to 1 as possible.

The Re ratio of the optical anisotropic material may be calculated out by: forming a layer made of the optical anisotropic material onto an isotropic substrate, such as a glass substrate, subjected to aligning treatment by forming an alignment layer made of a polyimide or the like; and then measuring the Re at a wavelength of 450 nm (Re₄₅₀) and the Re at a wavelength of 550 nm (Re₅₅₀).

The optical anisotropic material used in the mode is not particularly limited as far as the material has the Re ratio in the above-mentioned range. The optical anisotropic material may be a rodlike compound, a polymeric liquid crystalline material, or a polyimide material.

Examples of the polymeric liquid crystalline material include compounds described in JP-A Nos. 2002-265475, 2004-285174, and 8-278491.

Examples of the polyimide material include compounds described in JP-A Nos. 2004-78203, 2005-91625, and 2004-331951.

As the optical anisotropic material used in the mode, any one of the rodlike compound, the polymeric liquid crystalline material, and the polyimide material can be suitably used. It is particularly preferable to use the rodlike material. Since the rodlike compound can express a very good retardation property by a regular sequence thereof, the use of the rodlike material makes it easy to give a desired retardation property to the optical anisotropic film in the mode.

The “rodlike compound” in the mode refers to a compound having a molecular structure having a rodlike main skeleton.

The rodlike compound used in the mode is preferably a compound having a relatively small molecular weight. More specifically, a compound having a molecular weight in the range of 200 to 1200 is preferable, and a compound having a molecular weight in the range of 400 to 1000 is particularly preferable. The reason therefor is as follows: the optical anisotropic layer used in the mode contains the optical anisotropic material and the cellulose derivative that constitutes the transparent substrate which will be described later; the use of the compound having a relatively small molecular weight as the rodlike compound makes it easy to mix the rodlike compound with the cellulose derivative in the optical anisotropic layer.

In the case of using, as the rodlike compound, a material having a polymerizable functional group, the molecular weight of the rodlike compound is defined as the molecular weight of the monomer before it is polymerized.

The rodlike compound used in the mode is preferably a liquid crystalline material, which exhibits liquid crystallinity.

Since the liquid crystalline material has a property of exhibiting a regular sequence, the use of the liquid crystalline material makes it easy to give a desired retardation property to the optical anisotropic film in the mode.

As the liquid crystalline material, the following material is suitably used: a material which exhibits any one of a nematic phase, a cholesteric phase, a smectic phase, and other liquid crystalline phases. It is particularly preferable for the mode to use a liquid crystalline material exhibiting a nematic phase. The liquid crystalline material exhibiting a nematic phase makes it easier that the regular sequence is attained than liquid crystalline material exhibiting any other liquid crystalline phase.

Furthermore, it is preferable that the above liquid crystalline material showing the nematic phase is a molecule having a spacer on both ends of the mesogen. Since a liquid crystalline material having a spacer on both ends of the mesogen has the excellent flexibility, the transparency of the optical anisotropic film of the mode can be made excellent by using such liquid crystalline material.

As the rodlike compound used in the mode, those having a polymerizable functional group in a molecule can be used preferably. In particular, those having a three-dimensionally cross-linkable polymerizable functional group are preferable. Since the rodlike compound has a polymerizable functional group, the rodlike compound can be fixed by the polymerization. By fixing the rodlike compound, an optical anisotropic layer having the sequence stability and having difficulty in causing changes in retardation characteristics can be obtained.

In the mode, the rodlike compound having a polymerizable functional group and the rodlike compound not having a polymerizable functional group can be used as a mixture.

The “three-dimensional cross-linking” mentioned above denotes to three-dimensionally polymerize the liquid crystalline molecules with each other so as to be in a mesh-like (network) structure state.

As the polymerizable functional group, various polymerizable functional groups to be polymerized by the function of the ionizing radiation such as the ultraviolet ray and the electron beam, or the heat can be used without particular limitation. As the representative examples of these polymerizable functional groups, a radically polymerizable functional group, or a cation polymerizable functional group can be presented. Furthermore, as the representative examples of the radically polymerizable functional group, a functional group having at least one addition polymerizable ethylenically unsaturated double bond can be presented. As the specific examples, a vinyl group having or not having a substituent, or an acrylate group (the general term including an acryloyl group, a methacryloyl group, an acryloyloxy group, and a methacryloyloxy group) can be presented. Moreover, as the specific examples of the cation polymerizable functional group, an epoxy group, or the like can be presented. Additionally, as the polymerizable functional group, for example, an isocyanate group or an unsaturated triple bond can be presented. Among these examples, in terms of the process, a functional group having an ethylenically unsaturated double bond can be used preferably.

As the rodlike compound in the mode, a liquid crystalline material showing the liquid crystalline property, having the above-mentioned polymerizable functional group on the end is particularly preferable. By using such liquid crystalline material, a mesh-like (network) structure state can be provided by the three-dimensional polymerization with each other so as to obtain an optical anisotropic layer having the sequence stability and excellent optical characteristic realizing properties.

Even in the case of using a liquid crystalline material having, at a single terminal thereof, a polymerizable functional group in the mode, the material is crosslinked with a different molecule so that sequence stability can be attained.

The rodlike compound used in the mode is preferably a monofunctional polymerizable liquid crystalline material, which has in the molecule thereof a single polymerizable functional group as described above. Since the monofunctional polymerizable liquid crystalline material is very good in sequence property, the use of the monofunctional polymerizable liquid crystalline material makes it possible to render the optical anisotropic film in the mode a film very good in the performance of expressing optical anisotropy.

Specific examples of the rodlike compound used in the mode include compounds represented by the following formulae (1) to (6):

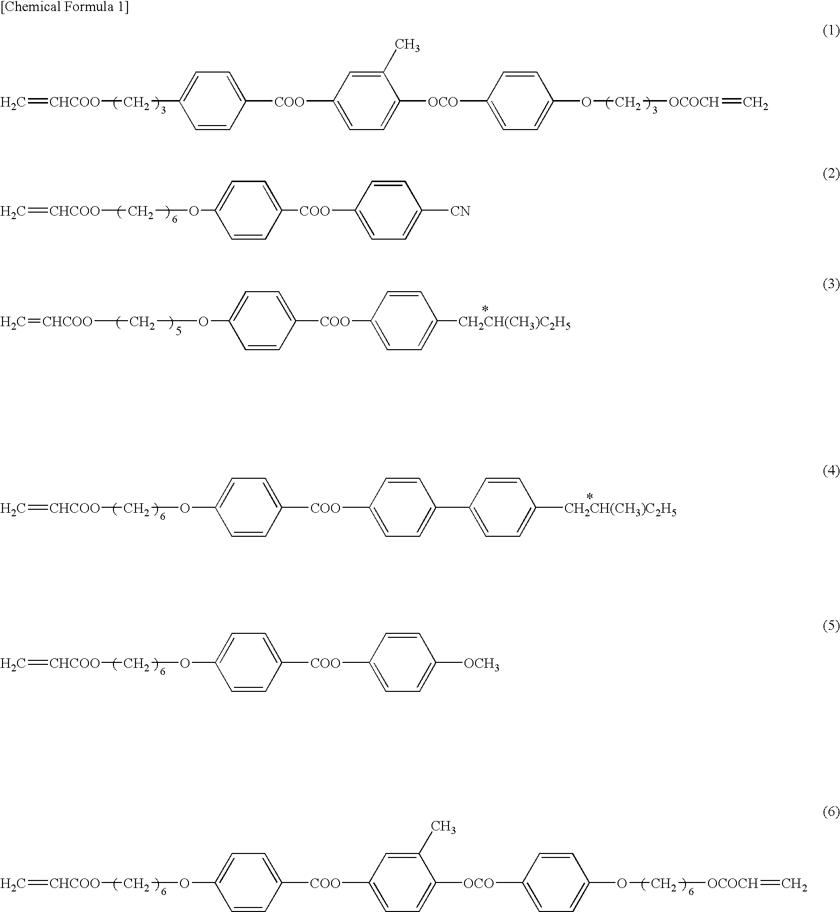

Here, the liquid crystalline materials represented by the chemical formulae (1), (2), (5) and (6) can be prepared according to the methods disclosed by D. J. Broer et, al., Makromol. Chem. 190, 3201-3215 (1989), or by D. J. Broer et, al., Makromol. Chem. 190, 2250 (1989), or by a similar method. Moreover, preparation of the liquid crystalline materials represented by the chemical formulae (3) and (4) is disclosed in DE 195,04,224.

Moreover, as the specific examples of the nematic liquid crystalline material having an acrylate group on the end, those represented by the following chemical formulae (7) to (17) can also be presented.

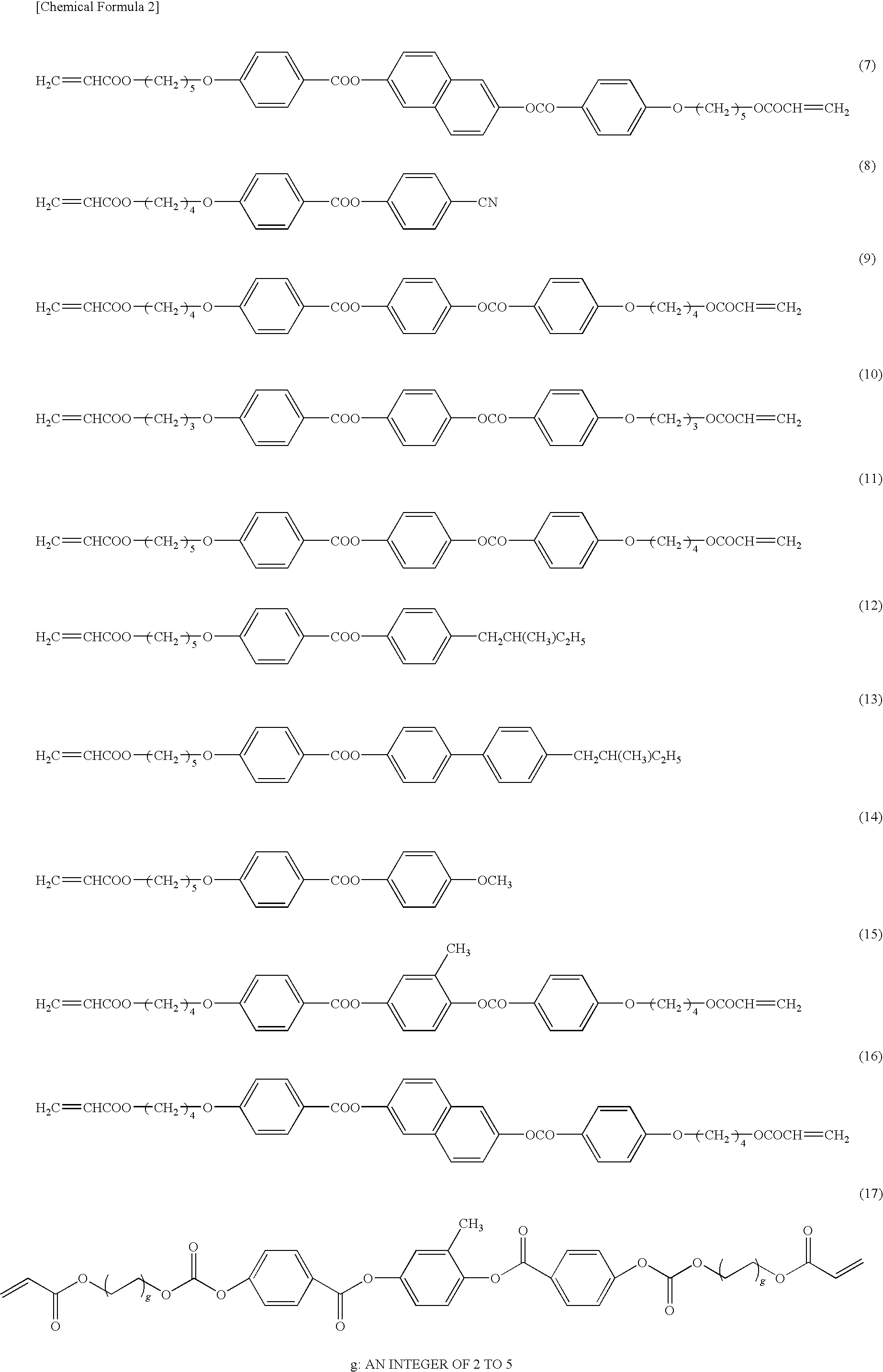

In the present embodiment, as the rodlike compound, only one kind may be used, or two or more kinds may be used as a mixture. For example, when a mixture of a liquid crystalline material having one or more polymerizable functional groups on the both ends and a liquid crystalline material having one or more polymerizable functional groups on one end is used, it is preferable because the polymerization density (cross-linking density) and the optical characteristics can be adjusted optionally by adjusting the composition ratio thereof.

Next, the cellulose derivative contained in the optical anisotropic layer in the mode is described. The resin material used in the mode is the cellulose derivative that constitutes the transparent substrate which will be described later. In the mode, the inclusion of the cellulose derivative in the optical anisotropic layer makes it possible to yield an optical anisotropic film very good in adhesion between the transparent substrate and the optical anisotropic layer.

The content of the cellulose derivative contained in the optical anisotropic layer in the mode is not particularly limited as far as the content permits the adhesion between the transparent substrate and the optical anisotropic layer to be set into a desired range in the optical anisotropic film in the mode. In the mode, the content of the cellulose derivative is preferably from 1 to 50% by mass, in particular preferably from 5 to 30% by mass.

The cellulose derivative is the same as used in the transparent substrate, thus, description thereof is omitted herein.

The optical anisotropic layer used in the mode may contain a compound other than the optical anisotropic material and the resin material. Examples of the other compound include silicone type leveling agents such as polydimethylsiloxane, methylphenylsiloxane, an organically modified siloxane; linear polymers such as polyalkyl acrylate, and polyalkylvinyl ether; surfactants such as fluorine-containing surfactants, and hydrocarbon surfactants; fluorine-containing leveling agents such as tetrafluoroethylene; and polymerization initiators.

In the case of using, as the optical anisotropic material, a rodlike compound having a polymerizable functional group polymerizable by irradiation with light in the mode, it is preferable that a photopolymerization initiator is contained as the other compound.

The photopolymerization initiator used in the mode is the same as described in the item “(1) Optical anisotropic film in the first mode”, thus, description thereof is omitted herein.

The content of the photopolymerization initiator is not particularly limited as far as the content permits the rodlike compound to be polymerized in a desired period. Usually, the content is preferably from 1 to 10 parts by weight, in particular preferably from 3 to 6 parts by weight for 100 parts by weight of the rodlike compound.

In the case of using the photopolymerization initiator, a photopolymerization initiator auxiliary agent may be used together. Examples of the photopolymerization initiator auxiliary agent include tertiary amines such as triethanolamine, and methyldiethanolamine, and benzoic acid derivatives such as 2-dimethylaminoethylbenzoic acid, and ethyl 4-dimethylamidebenzoate. However, the aid is not limited thereto.

In the optical anisotropic layer of the present embodiment, the following compounds may be added in the range not to deteriorate the purpose of the present invention. As the compound to be added, for example, polyester (meth)acrylate obtained by reacting (meth)acrylic acid with a polyester prepolymer obtained by condensation of a polyhydric alcohol and a monobasic acid or a polybasic acid; polyurethane (meth)acrylate obtained by reacting a polyol group and a compound having two isocyanate groups, and reacting the reaction product with (meth) acrylic acid; a photo polymerizable compound such as epoxy (meth)acrylate obtained by reacting (meth)acrylic acid with epoxy resins such as a bisphenol A type epoxy resin, a bisphenol F type epoxy resin, a novolak type epoxy resin, polycarboxylic acid glycidyl ester, polyol polyglycidyl ether, an aliphatic or alicyclic epoxy resin, an amino group epoxy resin, a triphenol methane type epoxy resin, and a dihydroxy benzene type epoxy resin; or a photo polymerizable liquid crystalline compound having an acrylic group or a methacrylic group can be presented. Since the compounds mentioned above are added, the mechanical strength of the optical anisotropic layer can be improved so that the stability may be improved.

The thickness of the optical anisotropic layer used in the mode is not particularly limited as far as the thickness permits the wavelength dependency of the Re of the optical anisotropic film in the mode to be made into a reverse dispersion type in accordance with the kind of the optical anisotropic material or that of the transparent substrate which will be described later. Usually, the thickness of the optical anisotropic layer in the mode is preferably from 0.5 to 20 μm.

b. Transparent Substrate

Next, the transparent substrate used in the mode is described. The transparent substrate used in the mode is made of the above-mentioned cellulose derivative, and has a Re exhibiting a wavelength dependency of a reverse dispersion type.

The transparent substrate used in the mode is not particularly limited as far as the substrate has a Re exhibiting a wavelength dependency of a reverse dispersion type. The transparent substrate used in the mode is preferably a substrate having a Re ratio of 0.3 to 1, in particular preferably a substrate having a Re ratio of 0.5 to 0.9. The use of the substrate having a Re ratio in the range makes it easy to render the retardation film of the invention a film having a Re exhibiting a wavelength dependency of a reverse dispersion type.

When the Re of the transparent substrate used in the mode is small so that the Re ratio is not precisely measured with ease, the ratio of the Rth at a wavelength of 450 nm (Rth₄₅₀) to the Rth at a wavelength of 550 nm (Rth₅₅₀) (Rth₄₅₀/Rth₅₅₀) (may simply referred to as “Rth ratio/” hereinafter) may be used as an index of the reverse dispersion instead of the Re ratio. Specifically, the transparent substrate used in the mode is preferably a transparent substrate having an Rth ratio of 0.3 to 1, and may be, particularly, a transparent substrate having an Rth of 0.5 to 0.9.

The structure of the transparent substrate used in the mode is not limited to a structure made of a single layer, and the transparent substrate may have a structure wherein plural layers are laminated onto each other.

When the transparent substrate has a structure wherein plural layers are laminated onto each other, the layers which have the same composition may be laminated or the layers which have different compositions may be laminated.

The transparency of the transparent substrate used in the present embodiment may be determined optionally according to factors such as the transparency required to the retardation film of the present invention. In general, it is preferable that the transmittance in a visible light zone is 80% or more, and it is more preferably 90% or more.

Here, the transmittance of the transparent substrate can be measured according to the JIS K7361-1 (Testing method of the total light transmittance of a plastic-transparent material).

The thickness of the transparent substrate used in the present embodiment is not particularly limited as long as necessary self supporting properties can be obtained according to factors such as the application of the retardation film of the present invention. In general, it is preferably in the range of 10 μm to 188 μm; it is more preferably in the range of 20 μm to 125 μm; and it is particularly preferably in the range of 30 μm to 80 μm.

In the case the thickness of the transparent substrate is thinner than the above-mentioned range, the necessary self supporting properties may not be provided to the retardation film of the present invention. Moreover, in the case the thickness is thicker than the above-mentioned range, for example, at the time of cutting process of the retardation film of the present invention, the process waste may be increased or wear of the cutting blade may be promoted.

The Re of the transparent substrate used in the mode is not particularly limited as far as the Re permits a desired retardation property to be given to the retardation film of the invention. The Re may be adjusted at will in accordance with the usage of the retardation film of the invention or a specific form of the optical anisotropic film used in the mode. About the transparent substrate used in the mode, the Re at 550 nm is preferably from 0 to 50 nm.

About the transparent substrate used in the mode, the Rth at a wavelength of 550 nm is preferably from 0 to 100 nm.

The wavelength dependency of the Re of the transparent substrate used in the mode may be of a reverse dispersion type, a normal dispersion type or a flat dispersion type. In the mode, the wavelength dependency is preferably of a reverse dispersion type.

When the wavelength dependency of the Re of the transparent substrate is of a reverse dispersion type, the retardation film of the invention can be rendered a film capable of expressing a viewing angle compensation function for a liquid crystal display in a wider wavelength range.

### 1-2. Second Embodiment

First, the optical anisotropic film of the second embodiment used in the invention is described. The optical anisotropic film of the present embodiment is a film having a Re the wavelength dependency of which exhibits normal dispersibility.

The optical anisotropic film of the embodiment is not particularly limited as far as the Re ratio thereof is larger than 1. It is advisable to adjust the Re appropriately in accordance with the usage of the retardation film of the invention, or some other factor. In particular, in the embodiment, the Re ratio is preferably from 1.01 to 1.3, in particular preferably from 1.01 to 1.2.

When the Re ratio is in the range, the retardation film of the invention can be rendered a film capable of improving the viewing angle property of a liquid crystal display in a wider wavelength range.

The optical anisotropic film of the embodiment is a film wherein a transparent substrate made of a cellulose derivative is used. The cellulose derivative, which constitutes the transparent substrate, is not particularly limited as far as the derivative is a cellulose derivative that has a desired water permeability, and makes the following possible: when the retardation film of the invention is used as a polarizing plate protective film, water contained in a polarizer in a polarizing plate producing step permeates the derivative so that a fall in the polarization property with time is restrained to a desired degree.

The transparent substrate used in the embodiment is the same as described in the item “1-1. First embodiment”, thus, description thereof is omitted herein.

The mode in which the transparent substrate is used in the optical anisotropic film of the embodiment is not particularly limited as far as the mode is a mode in which a desired optical anisotropy, a desired wavelength dependency of the Re, and desired other properties can be given to the optical anisotropic film of the embodiment. Examples of this mode include a mode in which the optical anisotropic film of the embodiment is made only of the transparent substrate, and a mode in which an optical anisotropic layer is laminated on the transparent substrate. The optical anisotropic film of the embodiment may be made into any one of these modes. In particular, the latter mode is preferable. This makes it easy to give a desired function to the optical anisotropic film of the embodiment in accordance with the usage of the retardation film of the invention, or some other factor.

The optical anisotropic film in the mode in which an optical anisotropic layer is laminated on the transparent substrate is not particularly limited as far as a desired function can be given to the retardation film of the invention. The optical anisotropic film of the embodiment is in particular preferably a mode in which an optical anisotropic film has the transparent substrate, and an optical anisotropic layer formed on the transparent substrate and containing not only the cellulose derivative which constitutes the transparent substrate but also an optical anisotropic material having a retardation exhibiting a wavelength dependency of a normal dispersion type. This mode makes it easy to adjust optical characteristics of the optical anisotropic film of the embodiment or the wavelength dependency of the Re into a desired range by changing the thickness of the optical anisotropic layer, or the like.

About this mode, the optical anisotropy of nx>ny can be given thereto by forming the optical anisotropic layer onto the transparent substrate, and then keeping the resultant as it is or optionally subjecting the resultant to stretching treatment.

The following will describe the optical anisotropic film in this mode in turn.

a. Optical Anisotropic Layer

The optical anisotropic material used in the optical anisotropic layer in the mode is not particularly limited as far as the material is a material having a retardation exhibiting a wavelength dependency of a normal dispersion type. The material that can be used may be appropriately selected from materials capable of giving a desired retardation property to the retardation film of the invention in accordance with the usage of the retardation film of the invention, or some other factor.

The optical anisotropic material used in the mode may be the same as described in the item “1-1. First embodiment”, thus, description thereof is omitted herein.

Next, the cellulose derivative contained in the optical anisotropic layer in the mode is described. The resin material used in the mode is the cellulose derivative that constitutes the transparent substrate which will be described later. In the mode, the inclusion of the cellulose derivative in the optical anisotropic layer makes it possible to yield an optical anisotropic film very good in adhesion between the transparent substrate and the optical anisotropic layer.

The content of the cellulose derivative contained in the optical anisotropic layer in the mode is not particularly limited as far as the content permits the adhesion between the transparent substrate and the optical anisotropic layer to be set into a desired range in the optical anisotropic film in the mode. In the mode, the content of the cellulose derivative is preferably from 1 to 50% by mass, in particular preferably from 5 to 30% by mass.

The cellulose derivative is the same as used in the above-mentioned transparent substrate, thus, description thereof is omitted herein.

The optical anisotropic layer used in the mode may contain a compound other than the optical anisotropic material and the resin material. The other compound may be the same as described in the item “1-1. First embodiment”, thus, description thereof is omitted herein.

The thickness of the optical anisotropic layer used in the mode is not particularly limited as far as the thickness permits the wavelength dependency of the Re of the optical anisotropic film in the mode to be made into a normal dispersion type in accordance with the kind of the optical anisotropic material or that of the transparent substrate which will be described later. In the mode, the thickness of the optical anisotropic layer is preferably from 0.5 to 20 μm.

b. Transparent Substrate

The transparent substrate used in the mode is a transparent substrate made of the above-mentioned cellulose derivative and having a Re exhibiting a wavelength dependency of a reverse dispersion type.

The transparent substrate used in the mode may be the same as described in the item “1-1. First embodiment”, thus, description thereof is omitted herein.

2. Retardation Layer

Next, the retardation layer used in the invention is described. The retardation layer used in the invention is a retardation layer wherein a liquid crystalline material is contained and between the refractive indexes “nx” and “ny” in arbitrary directions “x” and “y” of the in-plane direction which are perpendicular to each other and the refractive index “nz” in the thickness direction, the relation of nx≦ny<nz is realized.

In the invention, the use of the retardation layer wherein the “nx”, “ny” and “nz” satisfy this relation makes it possible to give the property of a positive C plate to the retardation film of the invention, therefore, the retardation film of the invention can be used suitably as a viewing angle compensation film for an IPS-mode retardation film.

The matter that the retardation layer used in the invention has the relation of nx≦ny<nz is equivalent in meaning to the matter that the liquid crystalline material in the retardation layer forms a homeotropic alignment.

Hereinafter, the retardation layer used in the invention will be described.

(1) Liquid Crystalline Material

First, the liquid crystalline material used in the invention is described. The liquid crystalline material used in the invention is not particularly limited as far as the material is a liquid crystal material which can give a retardation property satisfying the above-mentioned relation to the “nx”, “ny” and “nz” of the retardation layer. This liquid crystalline material is usually a homeotropic liquid crystalline material, wherein homeotropic alignment can be attained.

The homeotropic liquid crystalline material is not particularly limited as far as the material is a liquid crystalline material capable of forming a homeotropic alignment to give a desired retardation property to the retardation film of the invention. The homeotropic liquid crystalline material used in the invention is preferably a material having a polymerizable functional group. The use of this homeotropic liquid crystalline material makes it possible to cause molecules thereof to be polymerized through their polymerizable functional groups, so as to improve the mechanical strength of the retardation layer in the invention. Moreover, the use makes it possible to improve the alignment stability of the homeotropic liquid crystalline material in the retardation layer.

The polymerizable functional group may be one out of various polymerizable functional groups that are polymerized by effect of a ionizing radiation such as an ultraviolet ray or electron beam, or heat. Typical examples of these polymerizable functional groups include radical polymerizable functional groups, and cation polymerizable functional groups. A typical example of the radical polymerizable functional groups is a functional group having at least one ethylenical unsaturated double bond, which can undergo addition polymerization. Specific examples thereof include a substituted or unsubstituted vinyl and acrylate groups, the latter of which is a generic name of an acryloyl group, a methacryloyl group, an acryloyloxy group, and a methacryloyloxy group. Specific examples of the cation polymerizable functional groups include epoxy groups. Other examples of the polymerizable functional groups include isocyanate groups, and an unsaturated triple bond. Of these polymerizable functional groups, a functional group having an ethylenical unsaturated double bond is preferably used in the invention from the viewpoint of the process.

The homeotropic liquid crystalline material used in the invention may have plural ones or only one of the above-mentioned polymerizable functional groups.

Examples of the homeotropic liquid crystalline material include a material having a homeotropic alignment property that homeotropic alignment can be formed without using any vertical alignment layer (a first homeotropic liquid crystalline material), and a material which cannot form homeotropic alignment by itself but can form homeotropic alignment by use of a vertical alignment layer (a second homeotropic liquid crystalline material). Of course, in the invention, not only the first homeotropic liquid crystalline material but also the second homeotropic liquid crystalline material can be preferably used.

In the case of using the second homeotropic liquid crystalline material in the invention, the following method is usually used in order to cause the homeotropic liquid crystalline material to be homeotropically aligned in the retardation layer: a method of using, between the optical anisotropic film and the retardation layer, an alignment layer having an alignment regulating force for causing the liquid crystalline material to be homeotropically aligned, or using an alignment controlling compound having a function of causing the liquid crystalline material to be homeotropically aligned in the optical anisotropic layer. The method is disclosed in, for example, JP-A Nos. 10-319408, 2002-174724, and 2003-195035. A transfer process may be used which is a process of forming a retardation layer in which the second homeotropic liquid crystalline material is homeotropically aligned, separately, onto a different substrate such as a glass substrate, peeling this layer, and laminating the layer on the above-mentioned optical anisotropic film. The manner of forming the retardation layer on the glass substrate in the transfer process is disclosed in, for example, JP-A No. 2003-177242.

The first homeotropic liquid crystalline material is not particularly limited as far as the material is a material that can form homeotropic alignment without using any vertical alignment layer and give a desired retardation property to the retardation layer in the invention. Examples of the first homeotropic liquid crystalline material include a side chain type liquid crystal polymer containing monomer units each containing a liquid crystalline fragment side chain having positive refractive index anisotropy and monomer units each containing a non-liquid-crystalline fragment side chain; a side chain type liquid crystal polymer containing monomer units each containing the above-mentioned liquid crystalline fragment side chain and monomer units each containing a liquid crystalline fragment side chain having a cyclic structure of an alicyclic group, and other liquid crystal polymers. Examples of the liquid crystal polymers include compounds described in JP-A Nos. 2003-121853, 2002-174725, 2002-333642, and 2005-70098. The method for causing a compound other than liquid crystal polymer to be homeotropically aligned may be a method of using a surfactant having vertical alignment effect, or such an additive, and an example thereof is disclosed in JP-A No. 2002-148626. An example of using a polymerizable liquid crystal compound is disclosed in Japanese Patent Application National Publication No. 2000-514202.

In the meantime, the second homeotropic liquid crystalline material is not particularly limited as far as the material is a material that can form homeotropic alignment by use of a vertical alignment layer or the like, and can give a desired retardation property to the retardation layer in the invention. In the invention, a nematic liquid crystalline material exhibiting a nematic phase is in particular preferably used.

Specific examples of the second homeotropic liquid crystalline material used in the invention include compounds described in JP-A No. 7-258638, Japanese Patent Application National Publication No. 10-508882, and JP-A No. 2003-287623. In the invention, the compounds represented by formulae (1) to (17) illustrated above can be in particular preferably used as the second homeotropic liquid crystalline material.

Other examples of the second homeotropic liquid crystalline material used in the invention include compounds as described in JP-A No. 10-319408. In the invention, compounds represented by chemical formulae illustrated below can be in particular preferably used.

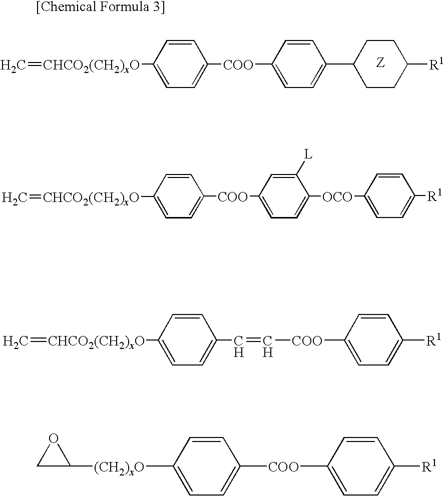

In the formulae, x is from 1 to 12, Z is a 1,4-phenylene or 1,4-cyclohexylene group, R¹ is a halogen, cyano, or an alkyl or alkoxy group having 1 to 12 carbon atoms, and L is H, a halogen, CN, or an alkyl, alkoxy or acyl group having 1 to 7 carbon atoms.

In the case of using, as the liquid crystalline material, a compound having a polymerizable functional group, the liquid crystalline material contained in the retardation layer in the invention becomes a polymer obtained by polymerization through the polymerizable functional group.

(2) Retardation Layer

The retardation layer in the invention may contain one liquid crystalline material or two or more liquid crystalline materials. In the case of using two or more liquid crystalline materials, a mixture of the above-defined first homeotropic liquid crystalline material and second homeotropic liquid crystalline material may be used.

The retardation layer in the invention may contain a compound other than the liquid crystalline material(s). The other compound is not particularly limited as far as the compound does not damage the sequence state of the liquid crystalline material(s) in the retardation layer or the performance of expressing the optical characteristics of the retardation layer. The compound may be appropriately selected in accordance with the usage of the retardation film used in the invention, or some other factor. A preferably used example of the other compound in the invention is an alignment controlling compound for aiding the formation of the homeotropic alignment of the liquid crystalline material(s). The use of the alignment controlling compound produces an advantage that the use of the second homeotropic liquid crystalline material becomes permissible. Even when the first homeotropic liquid crystalline material is used, the use of the alignment controlling compound produces an advantage that the regularity of the homeotropic alignment can be improved.

The alignment controlling compound is not particularly limited as far as the compound can give a desired homeotropic-alignment-regulating force to the retardation layer in the invention. The alignment controlling compound used in the invention is in particular preferably a surfactant. The surfactant is unevenly distributed into an air-interface of the retardation layer so that a specific direction of the molecules thereof can be arranged toward the retardation layer side, thus, the surfactant can easily give the above-mentioned homeotropic-alignment-regulating force to the retardation layer.

The surfactant used in the invention is, for example, a sulfonate surfactant. A fluorinated sulfonate surfactant is in particular preferably used.

A specific example of the fluorinated sulfonate surfactant is a product of trade name FC-4430 or FC-4432 (manufactured by 3M Company).

Examples of the above-mentioned other compound used in the invention include a polymerization initiator, a polymerization inhibitor, a plasticizer, a surfactant, and a silane coupling agent.

Compounds as described below may be added to the retardation layer in the invention as far as the objects of the invention are not damaged. As the above compounds which may be added, mention may be made, for example, of a polyester(metha)acrylate obtained by reacting (metha)acrylic acid with a polyester prepolymer which is obtained by condensing a polyvalent alcohol with a monobasic acid or a polybasic acid; a polyurethane(metha)acrylate obtained by mutually reacting a compound having a polyol group and a compound having two isocyanate groups and then reacting the reaction product thereof with (metha)acrylic acid; photopolymerizable compounds, such as epoxy(metha)acrylates, obtained by reacting (metha)acrylic acid with an epoxy resin such as a bisphenol A type epoxy resin, a bisphenol F type epoxy resin, a novolac type epoxy resin, a polycarboxylic acid polyglycidyl ester, polyol polyglycidyl ether, an aliphatic or alicyclic epoxy resin, an amino group epoxy resin, a triphenol methane type epoxy resin or a dihydroxy benzene type epoxy resin; and a photopolymerizable liquid crystalline compound having an acrylic group or a methacrylic group.

The thickness of the retardation layer in the invention is not particularly limited as far as the thickness permits a desired optical characteristic to be given to the retardation layer in accordance with the kind of the liquid crystalline material, or some other factor. The thickness is preferably from 0.5 to 10 μm, more preferably from 0.5 to 5 μm, in particular preferably from 1 to 3 μm.

The retardation layer in the invention exhibits retardation property. The retardation property can be adjusted at will in accordance with the usage of the retardation film of the invention, or some other factor. In the retardation layer used in the invention, the retardation in the thickness direction is preferably from −1000 to 0 nm.

The retardation layer used in the invention is formed on the above-mentioned optical anisotropic film, however, the mode in which the retardation layer is formed on the optical anisotropic film in the invention is not particularly limited, and may be appropriately selected in accordance with the objects of the invention. Accordingly, in the case of using, as the optical anisotropic film, for example, a film in a mode in which the optical anisotropic layer is laminated on the transparent substrate, the mode in which the retardation layer used in the invention is formed on the optical anisotropic film may be a mode in which the retardation layer is formed on the optical anisotropic layer or a mode in which the retardation layer is formed on the film surface opposite to the optical-anisotropic-layer-formed side of the film.

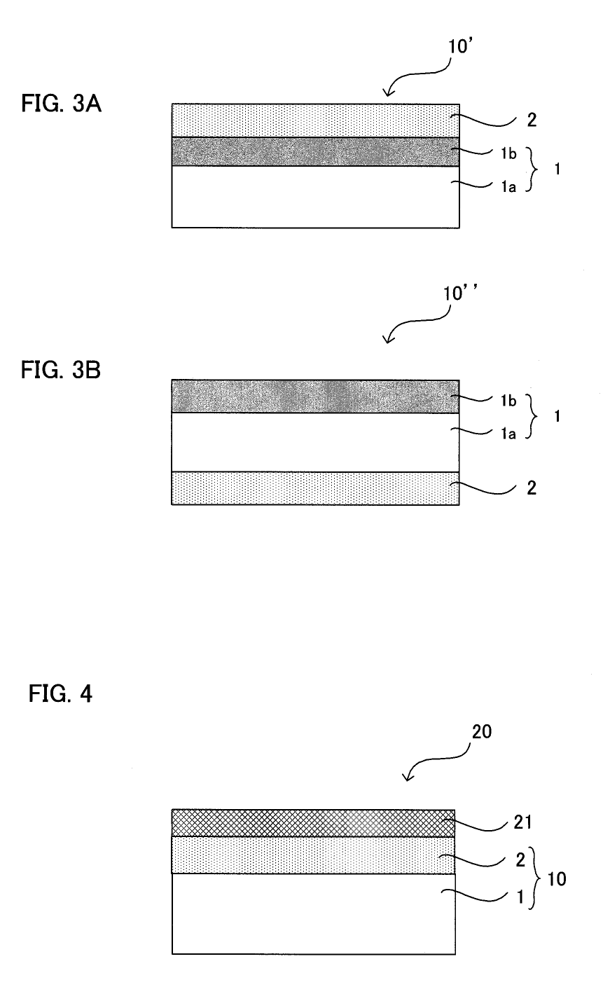

The modes, in which the retardation layer is formed, are specifically described with reference to some of the drawings. FIGS. 3A and 3B are each a schematic view illustrating an example of the mode in which the retardation layer is formed on the optical anisotropic film in the invention. As illustrated in FIGS. 3A and 3B, in a case where a retardation film 10′ or 10″ of the invention has a structure wherein an optical anisotropic film 1 in which an optical anisotropic layer 1b is formed on a transparent substrate 1a is used and a retardation layer 2 is formed on the optical anisotropic film 1, the mode in which the retardation layer 2 is formed on the optical anisotropic film 1 may be a mode in which the layer 2 is formed on the optical anisotropic layer 1b (FIG. 3A) or a mode in which the layer 2 is formed on the film surface opposite to the surface on which the optical-anisotropic-layer 1b is formed (FIG. 3B).

In the invention, any one of the modes can be preferably used.

About the mode in which the retardation layer is formed on the optical anisotropic layer side surface of the film, the optical anisotropic layer and the retardation layer are on the same side. As a result, the coating materials for the layers are continuously coated with ease so that the mode is easily produced, and surface scattering on the optical anisotropic layer can be cancelled out and further the film surface on the side opposite to the transparent substrate can be made naked so that the naked surface side can be laminated onto a polarizer or various functional layers such as an antireflective layer can be laminated on the naked surface side. Thus, the mode has an advantage that the degree of freedom in usage or in the specification of design becomes higher.

On the other hand, about the mode in which the retardation layer is formed on the film surface opposite to the surface on which the optical anisotropic layer is formed, interaction between the retardation layer and the optical functional layers is not generated, so that a shift or deviation from a retardation-designed value as described above is not easily generated. Thus, the mode has an advantage that a desired optical characteristic is easily given to the retardation layer.

Accordingly, it is advisable to select a more suitable mode appropriately from the above-mentioned two modes in accordance with a specific usage of the retardation film of the invention, performances required therefor, a design policy thereof and others, and use the selected mode.

3. Retardation Film

The retardation film of the invention has at least the above-mentioned optical anisotropic film, and the above-mentioned retardation layer. Optionally, any other constituent may be used therein. The arbitrary constituent used in the invention may be a constituent that has a desired function and is appropriately selected in accordance with the usage of the retardation film of the invention, or some other factor. This constituent is, for example, a transparent overcoat layer formed on the retardation layer. The use of this overcoat layer makes it possible to improve the durability of the retardation film even when an adhesive layer is laminated on the retardation layer side when the retardation film of the invention is used to produce a liquid crystal display.

The retardation property which the retardation film of the invention exhibits may be appropriately decided in accordance with the usage of the retardation film of the invention or some other factor. About the retardation film of the invention, the Nz factor thereof is preferably 1.0 or less, in particular preferably −1.5≦Nz≦1.0.

The Nz factor is a parameter for specifying the shape of the refractive index ellipsoid. Using the refractive indexes “nx” and “ny” in arbitrary directions “x” and “y” of the in-plane direction which are perpendicular to each other and the refractive index “nz” in the thickness direction, the Nz factor is represented by the following equation:

Nz=(nx−nz)/(nx−ny)

The Nz factor can be obtained by measuring the “nx”, “ny” and “nz” by, for example, a parallel Nicol rotation method using a KOBRA-WR manufactured by Oji Scientific Instruments, and then making a calculation in accordance with the equation.

The Re and Rth of the retardation film of the invention may also be appropriately decided in accordance with the usage of the retardation film of the invention, or some other factor. The Re of the retardation film of the invention is preferably from 0 to 300 nm at a wavelength of 550 nm.

About the Rth of the retardation film of the invention at a wavelength of 550 nm, the Rth preferably satisfies the following range: −600≦Rth<150.

The wavelength dependency of the Re of the retardation film of the invention may be of a reverse dispersion type, wherein the Re is smaller as the wavelength is shorter, or may be of a normal dispersion type, wherein the Re is larger as the wavelength is shorter. The wavelength dependency may be of a flat type, wherein the Re has no wavelength dependency. The wavelength dependency of the retardation film of the invention is preferably of a reverse dispersion type. This makes it possible to render the retardation film of the invention a film which can express a viewing angle compensation function of a liquid crystal in a wider wavelength range.

When the wavelength dependency of the Re of the retardation film of the invention is of a reverse dispersion type, the Re ratio is preferably 0.6 or more and less than 1.0, in particular preferably from 0.8 to 0.9.

The form of the retardation film of the invention is not particularly limited, and may be, for example, the form of a sheet which is consistent with the screen size of a liquid crystal display wherein the film is to be used, or the form of a long band.

4. Producing Method of the Retardation Film

Next, the producing method of the retardation film of the invention is described. The producing method of the retardation film of the invention is not particularly limited as far as the method is a method capable of producing the retardation film having the above-mentioned structure. Examples of this method include the following three methods.

The first method is a method including an optical anisotropic film forming step of using a transparent substrate made of a cellulose derivative and coating, on the transparent substrate, an optical-anisotropic-layer-forming coating solution containing the above-defined urethane resin or an optical anisotropic material exhibiting a wavelength dependency of a normal dispersion type, thereby forming an optical anisotropic film; a stretching step of stretching the optical anisotropic film, which is formed in the optical anisotropic film forming step; and a retardation layer forming step of forming, on the optical anisotropic layer of the optical anisotropic film, which is stretched in the stretching step, a retardation-layer-forming coating solution containing the above-defined liquid crystalline material, thereby forming a retardation layer on the optical anisotropic layer. The retardation layer forming step is a step of forming the retardation layer on the surface opposite to the optical-anisotropic-layer-formed surface of the optical anisotropic film.

The second method is a method including an optical anisotropic film forming step of using a transparent substrate made of a cellulose derivative and coating, on the transparent substrate, an optical-anisotropic-layer-forming coating solution containing the above-defined urethane resin or an optical anisotropic material exhibiting a wavelength dependency of a normal dispersion type, thereby forming an optical anisotropic film; a retardation layer forming step of forming, on the optical anisotropic layer of the optical anisotropic film, which is formed in the optical anisotropic film forming step, a retardation-layer-forming coating solution containing the above-defined liquid crystalline material, thereby forming a retardation layer on the optical anisotropic layer; and a stretching step of stretching the laminate of the optical anisotropic film and the retardation layer.

The retardation layer forming step is a step of forming the retardation layer on the surface opposite to the optical-anisotropic-layer-formed surface of the optical anisotropic film.

The third method is a method including an optical anisotropic film forming step of using a transparent substrate made of a cellulose derivative and coating, on the transparent substrate, an optical-anisotropic-layer-forming coating solution containing the above-defined urethane resin or an optical anisotropic material exhibiting a wavelength dependency of a normal dispersion type, thereby forming an optical anisotropic film; a stretching step of stretching the optical anisotropic film, which is formed in the optical anisotropic film forming step; and a retardation layer forming step of forming, on a substrate having a vertical alignment layer, a retardation layer containing the above-defined liquid crystalline material, and then bonding only the retardation layer onto the optical anisotropic layer of the optical anisotropic film through an adhesive layer. The retardation layer forming step is a step of forming the retardation layer on the surface opposite to the optical-anisotropic-layer-formed surface of the optical anisotropic film.

The retardation film of the invention can be produced by any one of these methods. According to the first method, the retardation film using the optical anisotropic film in the first mode can be more easily obtained.

In the case of using, as the optical anisotropic material, a rodlike compound having a polymerizable functional group in the first and second methods, a stable optical anisotropic layer can be formed by the matter that the optical anisotropic material is subjected to polymerization treatment. The timing at which the optical anisotropic material is subjected to the polymerization treatment may be before or after the stretching treatment.

The machine, the processing manner and others used in the stretching step may be basically the same machine as used in an ordinary stretching process of a synthetic resin film, and the stretching may be conducted under appropriate conditions, using the constituting materials of the optical anisotropic film and a desired retardation value.

The stretching may be monoaxial stretching treatment or biaxially stretching treatment. For the biaxially stretching treatment, unbalanced biaxially stretching treatment may be conducted. In unbalanced biaxially stretching treatment, a polymer film is stretched at a predetermined stretch ratio in some direction, and the film is stretched at a stretch ratio not less than the ratio in a direction perpendicular thereto. The stretching treatments in the two directions may be simultaneously conducted.

The stretching treatment is not particularly limited, and any stretching method may be appropriately conducted, examples thereof including roll stretching, long spacing stretching, tenter stretching, and tubular stretching. In the stretching treatment, it is preferable that the polymeric film is heated to, for example, the glass transition temperature thereof or higher and the melting temperature (or the melting point temperature) thereof or lower.

When the stretching step is carried out in the form of a roll-to-roll process, the mode of the stretching treatment may be a mode in which the film is stretched in a direction parallel to the carrying direction of the film (vertical direction, machine direction stretching) or a mode in which the film is stretched in a direction substantially perpendicular to the carrying direction of the film (transverse direction stretching).

The stretch ratio of the stretching treatment is appropriately decided in accordance with the retardation value to be obtained, and is not particularly limited. The ratio is preferably from 1.03 to 2 in order to make the retardation values of individual points in the in-plane direction of the film even.

Specific manners of carrying out the individual steps in each of the above-mentioned methods may be manners used to produce a retardation film for a liquid crystal display ordinarily. Thus, detailed description thereof is omitted herein.

B. Brightness Enhancement Film

Next, the brightness enhancement film of the invention is described. The brightness enhancement film of the invention is characterized by having a retardation film according to the invention, and a cholesteric liquid crystal layer formed on the retardation layer, which the retardation film has, and containing a liquid crystalline material in a cholesteric sequence state.

With reference to one of the drawings, the brightness enhancement film of the invention is described. FIG. 4 is a schematic view illustrating an example of the brightness enhancement film of the invention. As illustrated in FIG. 4, a brightness enhancement film 20 of the invention has a retardation film 10, and a cholesteric liquid crystal layer 21 formed on a retardation layer 2 which the retardation film 10 has and containing a liquid crystalline material in a cholesteric sequence state.

In this example, the brightness enhancement film 20 of the invention is characterized in that a retardation film according to the invention is used as the retardation film 10.

According to the invention, the use of the retardation film according to the invention as a polarizing plate protective film makes it possible to yield a brightness enhancement film very good in brightness enhancing function.

The brightness enhancement film of the invention has at least the above-mentioned retardation film and cholesteric liquid crystal layer.

Each of the constituents used in the brightness enhancement film of the invention will be described in detail hereinafter.

The retardation film used in the invention is the same as described in the item “A. Retardation film”, thus, description thereof is omitted herein.

1. Cholesteric Liquid Crystal Layer

First, the cholesteric liquid crystal layer used in the invention is described. The cholesteric liquid crystal layer used in the invention is a layer formed on the retardation layer which the retardation film has and having a liquid crystalline material in a cholesteric sequence state.

Hereinafter, the cholesteric liquid crystal layer used in the invention will be described in detail.

The cholesteric liquid crystal layer used in the invention is not particularly limited as far as the layer has a property that either of left-handed and right-handed circularly polarized light rays is reflected and other light rays are transmitted. The cholesteric liquid crystal layer used in the invention is preferably a layer exhibiting circular dichroism in at least one partial wavelength band of visible rays, or a layer exhibiting circular dichroism in a wavelength band of 200 nm or higher within the visible rays.

The cholesteric liquid crystal layer is, for example, an aligned liquid crystal polymer or a polymerized layer made from an aligned liquid crystal monomer. The cholesteric liquid crystal layer used in the invention may be a composite layer of these materials. Specific examples of the cholesteric liquid crystal layer used in the invention include layers described in JP-A No. 2004-198478.

The thickness of the cholesteric liquid crystal layer used in the invention is not particularly limited as far as the thickness permits a desired selectively-reflecting function to be given to the cholesteric liquid crystal layer. In the invention, the thickness is preferably from 1 to 30 μm, in particular preferably from 2 to 15 μm.

One or more additives may be optionally blended with the cholesteric liquid crystal layer used in the invention, examples of the additives including a polymer other than the above-mentioned liquid crystal polymer and a stabilizer, inorganic compounds such as a plasticizer, organic compounds, and metals and compounds thereof.

The cholesteric liquid crystal layer used in the invention may be rendered a layer on which circularly polarized light is reflected in a wide wavelength range, such as a visible ray wavelength range by making the layer into a configuration structure wherein two or more layers different from each other in reflection wavelength are combined with each other.

2. Producing Method of the Brightness Enhancement Film

The producing method of the brightness enhancement film of the invention is not particularly limited as far as the method makes it possible to produce the brightness enhancement film, which has the above-mentioned structure. The method may be, for example, a method of using the retardation film of the invention, and coating a cholesteric-liquid-crystal-layer-forming coating solution containing a nematic liquid crystalline material and a chiral agent on the retardation layer, which the retardation film has, thereby forming a cholesteric liquid crystal layer on the retardation layer.

The method for forming the cholesteric liquid crystal layer by use of the cholesteric-liquid-crystal-layer-forming coating solution is usually a method of coating the cholesteric-liquid-crystal-layer-forming coating solution on the retardation layer, next drying this solution, and then making the liquid crystalline material into a cholesteric sequence state. When a material having a polymerizable functional group is used as the liquid crystalline material, polymerizing treatment is conducted by radiation of ultraviolet rays or the like after the formation of the cholesteric sequence. Details of such a method are equivalent to those of a known method used to form a cholesteric liquid crystal layer ordinarily, thus, detailed description thereof is omitted herein.

C. Polarizing Plate

Next, the polarizing plate of the invention is described. The polarizing plate of the invention can be classified into two modes in accordance with the structure thereof.

Hereinafter, the polarizing plate of the invention will be divided into the modes, and the modes will be described in turn.

C-1: Polarizing Plate in the First Mode

First, the polarizing plate in the first mode of the invention is described. The polarizing plate in the mode is a polarizing plate wherein a retardation film according to the invention is used as a polarizing plate protective film.

Specifically, the polarizing plate in the mode has a retardation film according to the invention, a polarizer formed on the optical anisotropic film, which the retardation film has, and on the surface opposite to the film surface on which the retardation layer is formed, and a polarizing plate protective film formed on the polarizer.

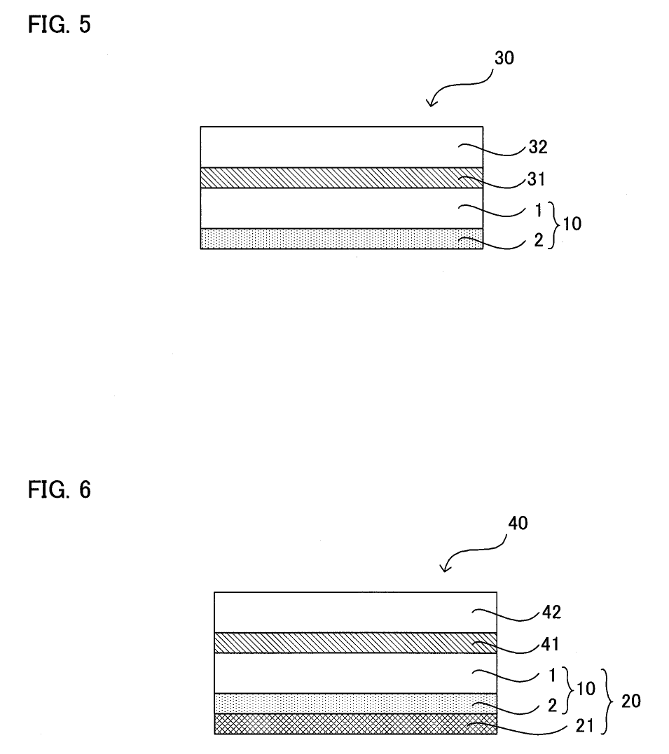

This polarizing plate in the mode is described with reference to one of the drawings. FIG. 5 is a schematic view illustrating an example of the polarizing plate in the mode. As illustrated in FIG. 5, a polarizing plate 30 in the mode has a retardation film 10, a polarizer 31 formed on an optical anisotropic film 1 which the retardation film 10 has, and a polarizing plate protective film 32 formed on the polarizer 31.

In this example, the polarizing plate 30 in the mode is characterized in that the retardation film 10 of the invention is used as the retardation film 10.

According to the mode, the use of the retardation film according to the invention as the polarizing plate protective film on one of both the sides makes it possible to yield a polarizing plate that is very good in durability and further has a viewing angle compensation function for an IPS mode liquid crystal display.

The polarizing plate in the mode has at least the above-mentioned retardation film, polarizer, and polarizing plate protective film.

Hereinafter, each of the constituents used in the polarizing plate in the mode will be described.

The retardation film used in the mode is the same as described in the item “A. Retardation film”, thus, description thereof is omitted herein.

1. Polarizing Plate Protective Film

First, the polarizing plate protective film used in the mode is described. The polarizing plate protective film used in the mode is a film having a function of preventing the polarizer in the polarizing plate in the mode from being exposed to water and others in the air, and a function of preventing the polarizer from being changed in dimension.

The polarizing plate protective film used in the mode is not particularly limited as far as the film is able to protect the polarizer in the polarizing plate in the mode and further has a desired transparency. About the polarizing plate protective film used in the mode, the transmittance is preferably 80% or more, more preferably 90% or more in the visible ray range.

The transmittance of the polarizing plate protective film can be measured JIS K7361-1 (Method for Testing the Total Transmittance of Plastic/Transparent Material).

As the material used for the polarizing plate protection film of the mode, cellulose derivatives, a cycloolefin resin, polymethyl methacrylate, polyvinyl alcohol, polyimide, polyallylate, polyethylene terephthalate, polysulfone, polyether sulfone, amorphous polyolefin, a modified acrylic based polymer, polystyrene, an epoxy resin, polycarbonate, polyesters, or the like can be presented. Among them, cellulose derivatives or the cycloolefin resin can be used preferably as the resin material.

The cellulose derivative may be, for example, the same as described as the cellulose derivative constituting the transparent substrate used in the optical anisotropic film in the item “A. Retardation film”.

The cycloolefin resin is not particularly limited as far as the resin is a resin having units of a monomer made of a cyclic olefin (cycloolefin). Examples of the monomer made of a cyclic olefin include norbornene, and polycyclic norbornene based monomers.

The cycloolefin resin used in the mode is preferably either cycloolefin polymer (COP) or cycloolefin copolymer (COC).

The cycloolefin resin used in the mode may be a homopolymer made from the monomer made of the cyclic olefin or may be a copolymer.

The cycloolefin resin used in the mode is preferably a resin having a saturated water absorption at 23° C. of 1% or less by mass, and is in particular preferably a resin having that of 0.1 to 0.7% by mass. The use of the cycloolefin resin makes it possible that the polarizing plate in the mode less undergoes a change in optical characteristics or dimension through the absorption of water.

The saturated water absorption is obtained by immersing the resin in water of 23° C. temperature for one week and then measuring the increased weight thereof in accordance with ASTM D570.

Furthermore, about the cycloolefin resin used in the mode, the glass transition point is preferably from 100 to 200° C., in particular from 100 to 180° C., more preferably from 100 to 150° C. When the glass transition point is in the range, the polarizing plate in the mode can be rendered a polarizing plate better in heat resistance and work-suitability.

Specific examples of the polarizing plate protective film made of a cycloolefin resin used in the mode include a Topas manufactured by Ticona GmbH, an ARTON manufactured by JSR Corp., a ZEONOR manufactured by Zeon Corp., a ZEONEX manufactured by Zeon Corp., and an APEL® many Mitsui Chemicals, Inc.

As the polarizing plate protective film used in the mode, either of a film made of the cellulose derivative and a film made of the cycloolefin resin is preferably used. In the mode, a polarizing plate protective film made of the cycloolefin resin is in particular preferably used. The reason therefor is as follows: The polarizing plate in the mode is a plate wherein a retardation film according to the invention is used as the polarizing plate protective film on one of both the sides, and the retardation film according to the invention is a film using an optical anisotropic film in which a transparent substrate made of a cellulose derivative is used. Accordingly, if the film made of the cellulose derivative is used as the polarizing plate protective film, the polarizing plate protective films on both the surfaces of the polarizing plate in the mode become films made of the cellulose derivative, so that the durability of its optical characteristics may be damaged.

However, when the polarizing plate protective film made of the cycloolefin resin or acrylic resin is used, the polarizing plate in the mode becomes a polarizing plate wherein the polarizing plate protective film, which is made of the cycloolefin resin or acrylic resin, is used on one of both the surfaces and the retardation film of the invention, which is made of a cellulose derivative, is used on the other surface, therefore, a fear as described above is less caused.

The structure of the polarizing plate protective film used in the invention is not limited to a structure made of a single layer, and the film may have a structure wherein plural layers are laminated onto each other.

When the film has a structure wherein plural layers are laminated onto each other, the layers which have the same composition may be laminated or the layers which have different compositions may be laminated.

2. Polarizer

Next, the polarizer used in the mode is described. The polarizer used in the mode has a function of giving polarization property to the polarizing plate in the mode.

The polarizer used in the mode is not particularly limited as far as the polarizer can give a desired polarization property to the polarizing plate in the mode, and may be selected without especial limitation from polarizer used generally in polarizing plate of liquid crystal displays. In the mode, the polarizer is usually a polarizer obtained by stretching a polyvinyl alcohol film and containing iodine.

3. Producing Method of the Polarizing Plate

The producing method of the polarizing plate in the mode is not particularly limited as far as the method makes it possible to produce the polarizing plate, which has the above-mentioned structure. The method is usually a method of causing the polarizing plate protective film and the retardation film to adhere onto the polarizer through an adhesive agent.

The retardation film and the polarizer are usually caused to adhere onto each other to make the slow axis direction of the retardation film perpendicular to the absorption axis direction of the polarizer.

The method for the adhesion between the polarizing plate protective film, the retardation film and the polarizer may be a method used to produce a polarizing plate used generally in a liquid crystal display. This method is, for example, a method described in Japanese Patent No. 3132122.

In the case of producing the polarizing plate in the mode industrially, there is usually used a method of using a polarizer, a polarizing plate protective film and a retardation film which are each formed in a long-band form, and causing these members to adhere onto each other while the long-band state is kept, thereby producing a product wounded into a roll form as the polarizing plate. In the case of producing the polarizing plate of the invention by such a method, the polarizing plate of the invention can be effectively produced through a roll-to-roll process by using, as the polarizer, a polarizer having an absorption axis the direction of which is parallel to the longitudinal direction, and using, as the retardation film, a film having a slow axis the direction of which is perpendicular to the longitudinal direction.

C-2: Polarizing Plate in the Second Mode

Next, the polarizing plate in the second mode of the invention is described. The polarizing plate in the mode is a polarizing plate wherein a brightness enhancement film according to the invention is used as the polarizing plate protective film.

Specifically, the polarizing plate in the mode has a brightness enhancement film according to the invention, a polarizer formed on the optical anisotropic film, which the brightness enhancement film has, and on the surface opposite to the retardation-layer-formed side surface of the film, and a polarizing plate protective film formed on the polarizer.

The polarizing plate in the mode is described with reference to one of the drawings. FIG. 6 is a schematic view illustrating an example of the polarizing plate in the mode. As illustrated in FIG. 6, a polarizing plate 40 in the mode has a brightness enhancement film 20, a polarizer 41 formed on a optical anisotropic film 1 which the brightness enhancement film 20 has, and a polarizing plate protective film 42 formed on the polarizer 41.

In this example, the polarizing plate 40 in the mode is characterized in that a brightness enhancement film of the invention is used as the brightness enhancement film 20.

According to the invention, the use of the brightness enhancement film according to the invention as the polarizing plate protective film on one of both the sides makes it possible to yield a polarizing plate that is very good in durability and further has a brightness enhancing function.

The polarizing plate in the mode has at least the above-mentioned brightness enhancement film, polarizer, and polarizing plate protective film.

The brightness enhancement film used in the mode is the same as described in the item “B. Brightness enhancement film”, thus, description thereof is omitted herein. The polarizer and the polarizing plate protective film used in the mode are the same as described in the item “C-1: Polarizing plate in the first mode”, thus, description thereof is omitted herein.

The producing method of the polarizing plate in the mode is not particularly limited as far as the method makes it possible to produce the polarizing plate, which has the above-mentioned structure. The method is usually a method of causing the polarizing plate protective film and the brightness enhancement film to adhere onto the polarizer through an adhesive agent.

The brightness enhancement film and the polarizer are usually caused to adhere onto each other to set the angle between the slow axis direction of the brightness enhancement film and the absorption axis direction of the polarizer into 45°.

The method for the adhesion between the polarizing plate protective film, the brightness enhancement film and the polarizer may be a method used to produce a polarizing plate used generally in a liquid crystal display. Thus, detailed description thereof is omitted herein.

D. Producing Method of a Retardation Film

Next, the producing method of a retardation film of the invention is described. The retardation-film-producing method of the invention can be roughly classified into 4 modes in accordance with the manner thereof. Accordingly, the retardation-film-producing method of the invention will be divided into the modes, and the modes will be described in turn.

D-1. Producing Method of a Retardation Film in the First Mode

First, the producing method of a retardation film in the first mode of the invention is described. The retardation-film-producing method in the mode includes: an optical anisotropic film forming step of using a transparent substrate made of a cellulose derivative and coating, on the transparent substrate, an optical-anisotropic-layer-forming coating solution wherein an optical anisotropic material having a retardation exhibiting a wavelength dependency of a normal dispersion type is dissolved in a solvent, thereby forming an optical anisotropic film wherein an optical anisotropic layer is formed on the transparent substrate; a stretching step of stretching the optical anisotropic film, which is formed in the optical anisotropic film forming step; and a retardation layer forming step of forming, on the optical anisotropic layer of the optical anisotropic film, which is stretched in the stretching step, a retardation layer containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized.

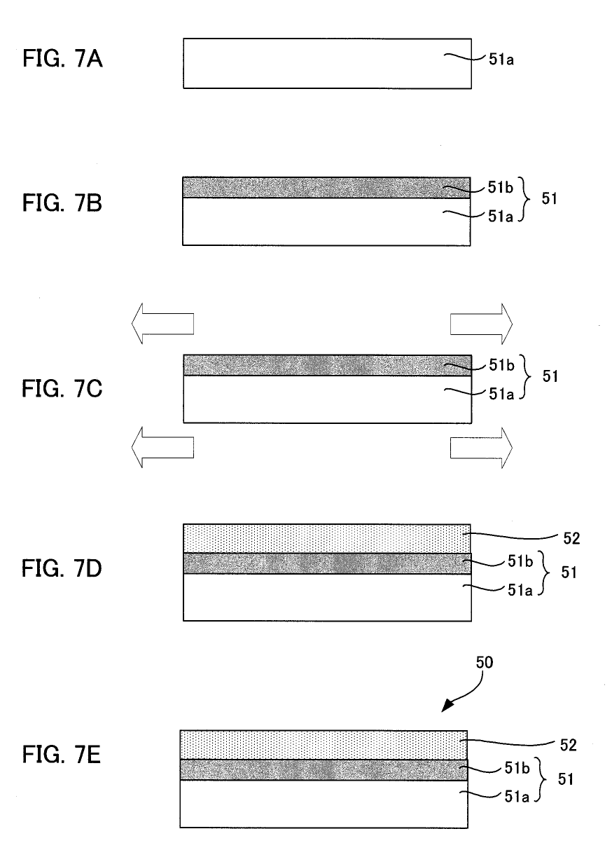

With reference to some of the drawings, the retardation-film-producing method in the mode is described. FIGS. 7A to 7E are schematic views illustrating an example of the retardation-film-producing method in the mode. As illustrated in FIGS. 7A to 7E, the retardation-film-producing method in the mode is a method including: an optical anisotropic film forming step (FIG. 7B) of using a transparent substrate 51a made of a cellulose derivative (FIG. 7A) and coating, on the transparent substrate 51a, an optical-anisotropic-layer-forming coating solution wherein an optical anisotropic material having a retardation exhibiting a wavelength dependency of a normal dispersion type is dissolved in a solvent, thereby forming an optical anisotropic film 51 wherein an optical anisotropic layer 51b is formed on the transparent substrate 51a; a stretching step (FIG. 7C) of stretching the optical anisotropic film 51, which is formed in the optical anisotropic film forming step; and a retardation layer forming step (FIG. 7D) of forming, on the optical anisotropic layer 51b of the optical anisotropic film 51, which is stretched in the stretching step, a retardation layer 52 containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized, thereby producing a retardation film 50 wherein the retardation layer 52 is formed on the optical anisotropic film 51 (FIG. 7E).

According to the mode, a substrate made of a cellulose derivative is used as the above-mentioned transparent substrate, thus, in the case of using the retardation film produced according to the mode as, for example, an inside polarizing plate protective film, a polarizing plate protective film made of a cycloolefin resin can be used as the corresponding outside polarizing plate protective film. Therefore, a polarizing plate very good in durability can be obtained. From such a matter, according to the mode, it is possible to produce a retardation film capable of forming a polarizing plate very good in durability.

The retardation-film-producing method in the mode has at least the optical anisotropic film forming step, the stretching step, and the retardation layer forming step, and may optionally have a different step.

Hereinafter, the individual steps used in the retardation-film-producing method in the mode will be described in turn.

1. Optical Anisotropic Film Forming Step

First, the optical anisotropic film forming step used in the mode is described. The step is a step of using a transparent substrate made of a cellulose derivative and coating, on the transparent substrate, an optical-anisotropic-layer-forming coating solution wherein an optical anisotropic material having a retardation exhibiting a wavelength dependency of a normal dispersion type is dissolved in a solvent, thereby forming an optical anisotropic film wherein an optical anisotropic layer is formed on the transparent substrate, characterized in that the solvent of the optical-anisotropic-layer-forming coating solution is a solvent containing a ketone solvent having a boiling point of 100° C. or higher. In the step, a solvent containing the ketone solvent is used as the solvent of the optical-anisotropic-layer-forming coating solution, thereby making it possible to form an optical anisotropic film small in haze.

Hereinafter, this optical anisotropic film forming step will be described in detail.

(1) Optical-Anisotropic-Layer-Forming Coating Solution

First, the optical-anisotropic-layer-forming coating solution used in the step is described. The optical-anisotropic-layer-forming coating solution used in the step is a solution wherein an optical anisotropic material having a retardation exhibiting a wavelength dependency of a normal dispersion type is dissolved in a solvent containing a ketone solvent having a boiling point of 100° C. or higher.

a. Solvent

The solvent used in the optical-anisotropic-layer-forming coating solution is not particularly limited as far as the solvent is a solvent wherein the optical anisotropic material can be dissolved into a desired concentration. In the step, it is preferred to use, as the solvent, a solvent containing a ketone solvent having a boiling point of 100° C. or higher. When the solvent containing the ketone solvent, which has a boiling point of 100° C. or higher, is used as the solvent used in the optical-anisotropic-layer-forming coating solution, an optical anisotropic film small in haze can be formed in the optical anisotropic film forming step.

The reason why an optical anisotropic film small in haze can be formed in the optical anisotropic film forming step by using the solvent containing the ketone solvent, which has a boiling point of 100° C. or higher, as the solvent used in the optical-anisotropic-layer-forming coating solution in the mode is unclear, but would be as follows.

The use of the ketone solvent, which has a boiling point of 100° C. or higher, makes it possible that when the optical-anisotropic-layer-forming coating solution is used to form an optical functional layer, the drying speed of the coated film can be made smaller, therefore, when the solvent volatizes from the substrate, the alignment property of the optical anisotropic material is not easily deteriorated and an inside scattering of the optical anisotropic layer can be restrained. For this reason, it appears that an optical functional layer which less gets cloud can be formed.

When a solvent containing a ketone solvent having a boiling point of 100° C. or higher is used as the solvent, the content of the ketone solvent contained in the solvent is not particularly limited as far as the content permits the optical anisotropic material which will be described later to be dissolved into a desired concentration. The solvent used in the step is preferably a solvent wherein the ketone solvent content (by percentage) is from 20 to 100% by mass, in particular preferably a solvent wherein the content is from 50 to 100% by mass. When the ketone solvent content is in the range, an optical anisotropic film smaller in haze can be formed in the step.

The ketone solvent content in the solvent used in the step is a value measured by gas chromatography under the following conditions:

(1) Measuring device: Shimadzu Corp.

### (2) Detector: FID

### (3) Column: SBS-200 3m

(4) Column temperature: 100° C.
(5) Injection temperature: 150° C.

### (6) Carrier gas: He 150 kPa

(7) Hydrogen pressure: 60 kPa
(8) Air pressure: 50 kPa

The ketone solvent used in the step is not particularly limited as far as the solvent has a boiling point of 100° C. or higher. The solvent that can be used may be appropriately selected in accordance with the optical anisotropic material which will be described later, the kind of a different solvent that may be used together with the ketone solvent, or some other factor. The ketone solvent used in the step is a solvent the boiling point of which is preferably 100° C. or higher, in particular preferably 120° C. or higher, more preferably from 130 to 170° C.

The ketone solvent used in the invention is preferably a solvent having a desired dissolving performance to cellulose acetate. More specifically, the solubility parameter (SP value) thereof to cellulose acetate is preferably from 8 to 13 (Cal/cm⁻³)^{1/2}, in particular preferably 9 to 12 (Cal/cm⁻³)^{1/2}.

Specific examples of the ketone solvent used in the step include cyclopentanone, cyclohexanone, and methyl isobutyl ketone. In the step, any one of these ketone solvents can be preferably used. It is particularly preferable to use cyclopentanone or cyclohexanone. When cyclopentanone or cyclohexanone is used as the ketone solvent, an optical anisotropic film smaller in haze can be formed in the optical anisotropic film forming step. As a result, a retardation film better in transparency can be produced according to the mode.

About the ketone solvent used in the step, one or more species thereof may be used.

The mode in which the solvent used in the step contains the ketone solvent may be a mode in which only the ketone solvent is used, or a mode in which the ketone solvent is mixed with a different solvent.

When the solvent used in the step is the mode in which the ketone solvent is mixed with a different solvent, the different solvent is not particularly limited as far as the solvent makes it possible to set the solubility of the optical anisotropic material which will be described later in the solvent used in the step into a desired range. Examples of the different solvent include methyl ethyl ketone, isopropyl alcohol, n-propyl alcohol, toluene, isobutanol, N-butanol, and ethyl acetate.

About the different solvent used in the step, only one species, or more species thereof may be used.

b. Optical Anisotropic Material

The optical anisotropic material used in the step is not particularly limited as far as the material has a retardation exhibiting a wavelength dependency of a normal dispersion type. The optical anisotropic material used in the step is the same as described in the item “A. Retardation film”, thus, description thereof is omitted herein.

The content of the optical anisotropic material in the optical-anisotropic-layer-forming coating solution used in the step is not particularly limited as far as the content permits the viscosity of the optical-anisotropic-layer-forming coating solution to be set into a desired range in accordance with the manner of coating this coating solution onto the transparent substrate which will be described later in the step, or some other factor. In the step, the content is preferably from 5 to 50% by mass, in particular preferably from 5 to 40% by mass, more preferably from 5 to 30% by mass.

c. Optical-Anisotropic-Layer-Forming Coating Solution

The optical-anisotropic-layer-forming coating solution used in the step may contain a compound other than the solvent and the optical anisotropic material. Examples of the other compound include silicone type leveling agents such as polydimethylsiloxane, methylphenylsiloxane, an organically modified siloxane; linear polymers such as polyalkyl acrylate, and polyalkylvinyl ether; surfactants such as fluorine-containing surfactants, and hydrocarbon surfactants; fluorine-containing leveling agents such as tetrafluoroethylene; and polymerization initiators.

In the case of using, as the optical anisotropic material, a rodlike compound having a polymerizable functional group polymerizable by irradiation with light in the step, it is preferable that a polymerization initiator is contained as the other compound.

The photopolymerization initiator used in the mode is the same as described in the item “A. Retardation film”, thus, description thereof is omitted herein.

Furthermore, in the case of using the photo polymerization initiating agent, a photo polymerization initiating auxiliary agent can be used in combination. As such a photo polymerization initiating auxiliary agent, tertiary amines such as triethanol amine, and methyl diethanol amine; benzoic acid derivatives such as 2-dimethyl aminoethyl benzoic acid and 4-dimethyl amide ethyl benzoate, or the like can be presented, however, it is not limited thereto.

In the optical-anisotropic-layer-forming coating solution, the following compounds may be added. As the compound to be added, for example, polyester(meth)acrylate obtained by reacting (meth)acrylic acid with a polyester prepolymer obtained by condensation of a polyhydric alcohol and a monobasic acid or a polybasic acid; polyurethane(meth)acrylate obtained by reacting a polyol group and a compound having two isocyanate groups, and reacting the reaction product with (meth)acrylic acid; a photo polymerizable compound such as epoxy(meth)acrylate obtained by reacting (meth) acrylic acid with epoxy resins such as a bisphenol A type epoxy resin, a bisphenol F type epoxy resin, a novolak type epoxy resin, polycarboxylic acid glycidyl ester, polyol polyglycidyl ether, an aliphatic or alicyclic epoxy resin, an amino group epoxy resin, a triphenol methane type epoxy resin, and a dihydroxy benzene type epoxy resin; or a photo polymerizable liquid crystalline compound having an acrylic group or a methacrylic group can be presented.

(2) Transparent Substrate

The transparent substrate used in the step is a substrate made of a cellulose derivative. The transparent substrate used in the step is the same as described in the item “A. Retardation film”, thus, description thereof is omitted herein.

(3) Method for Forming the Optical Anisotropic Layer

Next, described is the method of coating the optical-anisotropic-layer-forming coating solution on the transparent substrate in the step, thereby forming the optical anisotropic layer.

The method of coating the optical-anisotropic-layer-forming coating solution on the transparent substrate in the step is not particularly limited as far as the method makes it possible to attain an even thickness and a desired flatness. Examples of the method include gravure coating, reverse coating, knife coating, dip coating, spray coating, air knife coating, spin coating, roll coating, printing, a dipping and pulling-up method, curtain coating, die coating, casting, bar coating, extrusion coating, and E type coating.

The thickness of the coated film formed by coating the optical-anisotropic-layer-forming coating solution on the transparent substrate in the step is not particularly limited as far as the thickness permits desired optical specifications (Re and wavelength dependency) to be attained. In the step, the thickness is preferably from 0.1 to 50 μm, in particular from 0.5 to 30 μm, more preferably from 0.5 to 20 μm. If the thickness of the coated film from the optical-anisotropic-layer-forming coating solution is smaller than the range, the flatness of the optical anisotropic layer formed in the step may be damaged. If the thickness is larger than the range, the load against the drying of the solvent increases so that the productivity may fall.

The method for drying the coated film from the optical-anisotropic-layer-forming coating solution in the step may be an ordinarily-used drying method, such as heat drying, pressure-reduced drying, or gap drying method. The drying method used in the step is not limited to a single method, and may be a method in which plural drying manners are adopted according to, for example, a mode in which the drying method is successively varied in accordance with the remaining amount of the solvent.

In the case of using, as the optical anisotropic material, a compound having a polymerizable functional group, the coated film from the optical-anisotropic-layer-forming coating solution is dried and subsequently polymerization treatment for polymerizing the optical anisotropic material is conducted. It is advisable to decide, as this polymerization treatment, a treatment in accordance with the kind of the polymerizable functional group. The polymerization treatment is usually irradiation treatment with ultraviolet rays or visible rays, heating treatment, or the like.

The timing at which the polymerization treatment is conducted may be after the coated film from the optical-anisotropic-layer-forming coating solution is dried in the step, or after the stretching step which will be described below subsequent to the drying of the coated film from the optical-anisotropic-layer-forming coating solution.

2. Stretching Step

Next, the stretching step used in the mode is described. The step is a step of stretching the optical anisotropic film, which is formed in the optical anisotropic film forming step.

The mode in which the optical anisotropic film is stretched in the step is not particularly limited as far as the mode is a mode making it possible to give a desired optical anisotropy to the optical anisotropic film. Accordingly, the stretching mode used in the step may be monoaxial stretching or biaxially stretching. In the step, it is preferable to stretch the optical anisotropic film according to a mode of expressing an optical anisotropy that between the refractive index “nx” in the slow axis direction of the in-plane direction and the refractive index “ny” in the fast axis direction of the in-plane direction, the relation of nx>ny is realized.

When the optical anisotropic film is biaxially stretched in the step, unbalanced biaxially stretching may be used. In the case of using unbalanced biaxially stretching, a method is usually used wherein the optical anisotropic film is stretched at a predetermined stretch ratio in some direction, and the film is stretched at a stretch ratio not less than the ratio in a direction perpendicular thereto. The stretching treatments in the two directions may be simultaneously conducted.

In the step, the stretch ratio at which the optical anisotropic film is stretched is not particularly limited as far as the ratio permits a desired optical anisotropy to be given to the optical anisotropic film. In the step, the ratio is preferably from 1.01 to 1.4, in particular preferably from 1.1 to 1.4, more preferably from 1.15 to 1.35.

The stretching method used in the step is not particularly limited as far as the method is a method making it possible to stretch the optical anisotropic film at a desired stretch ratio. Examples of the stretching method used in the step include roll stretching, long spacing stretching, tenter stretching, and tubular stretching. In order to conduct adhesion between the film and a polarizer in a roll-to-roll manner, it is desired to use tenter stretching.

In the step, it is preferable that the optical anisotropic film is stretched in the state that the film is heated to the glass transition temperature thereof or higher and the melting temperature (or the melting point temperature) thereof or lower.

3. Retardation Layer Forming Step

Next, the retardation layer forming step used in the mode is described. The step is a step of forming, on the optical anisotropic layer of the optical anisotropic film, which is stretched in the stretching step, a retardation layer containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized.

The method for forming the retardation layer on the optical anisotropic layer in the step is not particularly limited as far as the method is a method making it possible to form a retardation layer containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized. This method may be, for example, a method of coating a retardation-layer-forming coating solution wherein a homeotropic liquid crystalline material is dissolved in a solvent on the optical anisotropic layer, or a transfer method of forming a retardation layer in which a homeotropic liquid crystalline material is homeotropically aligned, separately, onto a different substrate such as a glass substrate, peeling this layer, and laminating the layer on the above-mentioned optical anisotropic film. About these methods, the former is the same as disclosed in, for example, JP-A Nos. 10-319408 and 2002-174724, Japanese Patent Application National Publication No. 2000-514202, and JP-A No. 2003-195035, and the latter is the same as disclosed in, for example, JP-A No. 2003-177242, thus, description thereof is omitted herein.

The liquid crystalline material used in the step is the same as described in the item “A. Retardation film”, thus, description thereof is omitted herein.

D-2. Producing Method of a Retardation Film in the Second Mode.

Next, the producing method of a retardation film in the second mode of the invention is described. The retardation-film-producing method in the mode has: an optical anisotropic film forming step of using a transparent substrate made of a cellulose derivative and coating, on the transparent substrate, an optical-anisotropic-layer-forming coating solution wherein an optical anisotropic material having a retardation exhibiting a wavelength dependency of a normal dispersion type is dissolved in a solvent, thereby forming an optical anisotropic film wherein an optical anisotropic layer is formed on the transparent substrate; a retardation layer forming step of forming, on the optical anisotropic layer of the optical anisotropic film, which is formed in the optical anisotropic film forming step, a retardation layer containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized, thereby forming an optical laminate wherein the retardation layer is formed on the optical anisotropic layer; and a stretching step of stretching the optical laminate, which is formed in the retardation layer forming step.

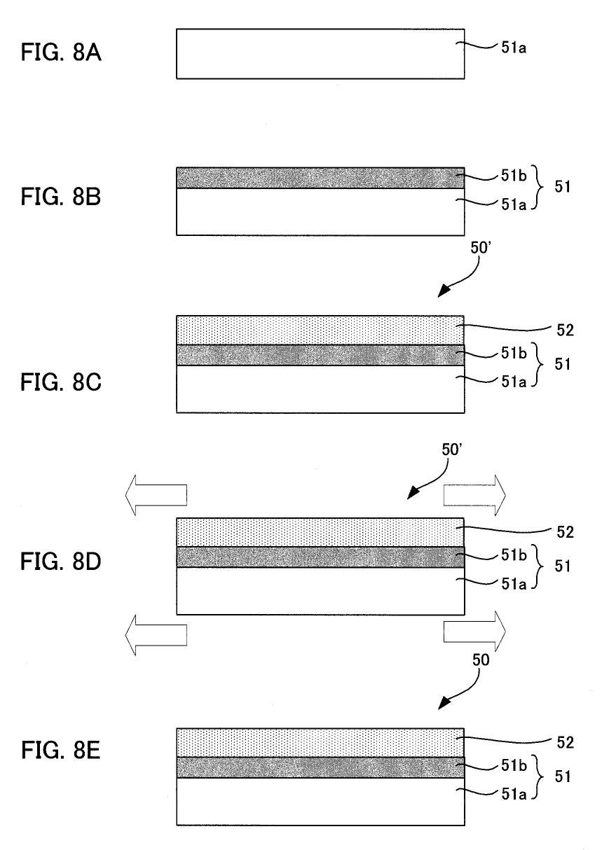

With reference of some of the drawings, the retardation-film-producing method in the mode is described. FIGS. 8A to 8E are schematic views illustrating an example of the retardation-film-producing method in the mode. As illustrated in FIGS. 8A to 8E, the retardation-film-producing method in the mode is a method including an optical anisotropic film forming step (FIG. 8B) of using a transparent substrate 51a made of a cellulose derivative (FIG. 8A) and coating, on the transparent substrate 51a, an optical-anisotropic-layer-forming coating solution wherein an optical anisotropic material having a retardation exhibiting a wavelength dependency of a normal dispersion type is dissolved in a solvent, thereby forming an optical anisotropic film 51 wherein an optical anisotropic layer 51b is formed on the transparent substrate 51a, a retardation layer forming step (FIG. 8C) of forming, on the optical anisotropic layer 51b of the optical anisotropic film 51, which is formed in the optical anisotropic film forming step, a retardation layer 52 containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized, thereby forming an optical laminate 50′ wherein the retardation layer 52 is formed on the optical anisotropic layer 51b, and a stretching step (FIG. 8D) of stretching the optical laminate 50′, which is formed in the retardation layer forming step, thereby producing a retardation film 50 wherein the retardation layer 52 is formed on the optical anisotropic film 51 (FIG. 8E).

According to the mode, a substrate made of a cellulose derivative is used as the above-mentioned transparent substrate, thus, in the case of using the retardation film produced according to the mode as, for example, an inside polarizing plate protective film, a polarizing plate protective film made of a cycloolefin resin can be used as the corresponding outside polarizing plate protective film. Therefore, a polarizing plate very good in durability can be obtained. From such a matter, according to the mode, it is possible to produce a retardation film capable of forming a polarizing plate very good in durability.

The retardation-film-producing method in the mode has at least the optical anisotropic film forming step, the retardation layer forming step, and the stretching step, and may optionally have a different step.

Hereinafter, the individual steps used in the retardation-film-producing method in the mode will be described in turn.

1. Optical Anisotropic Film Forming Step

First, the optical anisotropic film forming step used in the mode is described. This step is a step of using a transparent substrate made of a cellulose derivative and coating, on the transparent substrate, an optical-anisotropic-layer-forming coating solution wherein an optical anisotropic material having a retardation exhibiting a wavelength dependency of a normal dispersion type is dissolved in a solvent, thereby forming an optical anisotropic film wherein an optical anisotropic layer is formed on the transparent substrate.

The method for forming the optical anisotropic film in the step is the same as described in the item “D-1. Producing method of a retardation film in the first mode”, thus, description thereof is omitted herein.

2. Retardation Layer Forming Step

Next, the retardation layer forming step used in the mode is described. This step is a step of forming, on the optical anisotropic layer of the optical anisotropic film, which is formed in the optical anisotropic film forming step, a retardation layer containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized, thereby forming an optical laminate wherein the retardation layer is formed on the optical anisotropic layer.

The method for forming the retardation layer on the optical anisotropic layer to form the optical laminate is the same as described in the item “D-1. Producing method of a retardation film in the first mode”, thus, description thereof is omitted herein.

3. Stretching Step

Next, the stretching step used in the mode is described. The step is a step of stretching the optical laminate, which is formed in the retardation layer forming step.

The optical laminate is stretched in the step, thereby turning to a retardation film having a predetermined retardation.

The method for stretching the optical laminate in the step is not particularly limited as far as the method makes it possible to form a retardation film having a desired retardation.

The stretching method used in the step is the same as described in the item “D-1. Producing method of a retardation film in the first mode”, thus, description thereof is omitted herein.

D-3. Producing Method of a Retardation Film in the Third Mode

Next, the producing method of a retardation film in the third mode of the invention is described. The retardation-film-producing method in the mode has: an optical anisotropic film forming step of using a transparent substrate made of a cellulose derivative and coating, on the transparent substrate, an optical-anisotropic-layer-forming coating solution wherein an optical anisotropic material having a retardation exhibiting a wavelength dependency of a normal dispersion type is dissolved in a solvent, thereby forming an optical anisotropic film wherein an optical anisotropic layer is formed on the transparent substrate; a stretching step of stretching the optical anisotropic film, which is formed in the optical anisotropic film forming step; and a retardation layer forming step of forming, on the surface opposite to the optical-anisotropic-layer-formed surface of the optical anisotropic film, which is stretched in the stretching step, a retardation layer containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized.

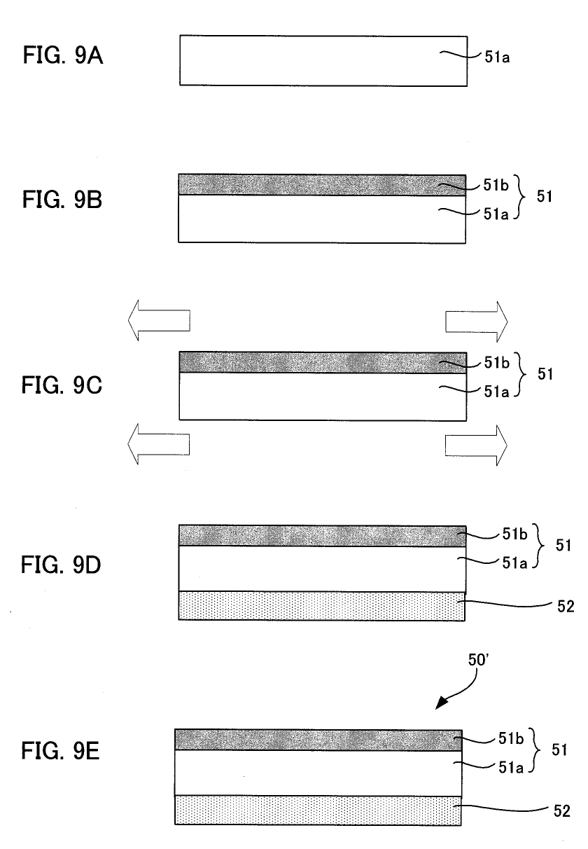

With reference to some of the drawings, the retardation-film-producing method in the mode is described. FIGS. 9A to 9E are schematic views illustrating an example of the retardation-film-producing method in the mode. The retardation-film-producing method in the mode includes an optical anisotropic film forming step (FIG. 9B) of using a transparent substrate 51a made of a cellulose derivative (FIG. 9A) and coating, on the transparent substrate 51a, an optical-anisotropic-layer-forming coating solution wherein an optical anisotropic material having a retardation exhibiting a wavelength dependency of a normal dispersion type is dissolved in a solvent, thereby forming an optical anisotropic film 51 wherein an optical anisotropic layer 51b is formed on the transparent substrate 51a, a stretching step (FIG. 9C) of stretching the optical anisotropic film 51, which is formed in the optical anisotropic film forming step, and a retardation layer forming step (9D) of forming, on the surface opposite to the optical-anisotropic-layer-51b-formed surface of the optical anisotropic film 51, which is stretched in the stretching step, a retardation layer 52 containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized, thereby producing a retardation film 50′ wherein the retardation layer 52 is formed on the optical anisotropic film 51 (FIG. 9E).

According to the mode, a substrate made of a cellulose derivative is used as the above-mentioned transparent substrate, thus, in the case of using the retardation film produced according to the mode as, for example, an inside polarizing plate protective film, a polarizing plate protective film made of a cycloolefin resin can be used as the corresponding outside polarizing plate protective film. Therefore, a polarizing plate very good in durability can be obtained.

Moreover, according to the mode, the retardation layer forming step is the step of forming, on the surface opposite to the optical-anisotropic-layer-formed surface of the optical anisotropic film, a retardation layer, thus, a layer very good in the performance of expressing retardation property can easily be formed as the retardation layer.

From such matters, according to the mode, it is possible to produce a retardation film capable of forming a polarizing plate very good in durability.

The retardation-film-producing method in the mode has at least the optical anisotropic film forming step, the stretching step, and the retardation layer forming step and may optionally have a different step.

The optical anisotropic film forming step and the stretching step in the mode are the same as described in the item “D-1. Producing method of a retardation film in the first mode”.

Accordingly, only the retardation layer forming step used in the mode will be described hereinafter.

The retardation layer forming step used in the mode is described. The step is a step of forming, on the surface opposite to the optical-anisotropic-layer-formed surface of the optical anisotropic film, which is stretched in the stretching step, a retardation layer containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized.

The method for forming the retardation layer on the optical anisotropic film in the step is not particularly limited as far as the method makes it possible to form, on the surface opposite to the optical-anisotropic-layer-formed surface, a retardation layer containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized. This method is the same as described in the item “D-1. Producing method of a retardation film in the first mode” except that the retardation layer is formed on the surface opposite to the optical-anisotropic-layer-formed surface of the optical anisotropic film, thus, detailed description thereof is omitted herein.

D-4. Producing Method of a Retardation Film in the Fourth Mode

Next, the producing method of a retardation film in the fourth mode of the invention is described. The retardation-film-producing method in the mode has an optical anisotropic film forming step of using a transparent substrate made of a cellulose derivative and coating, on the transparent substrate, an optical-anisotropic-layer-forming coating solution wherein an optical anisotropic material having a retardation exhibiting a wavelength dependency of a normal dispersion type is dissolved in a solvent, thereby forming an optical anisotropic film wherein an optical anisotropic layer is formed on the transparent substrate, a retardation layer forming step of forming, on the surface opposite to the optical-anisotropic-layer-formed surface of the optical anisotropic film, which is formed in the optical anisotropic film forming step, a retardation layer containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized, thereby forming an optical laminate wherein the retardation layer is formed on the optical anisotropic layer, and a stretching step of stretching the optical laminate, which is formed in the retardation layer forming step.

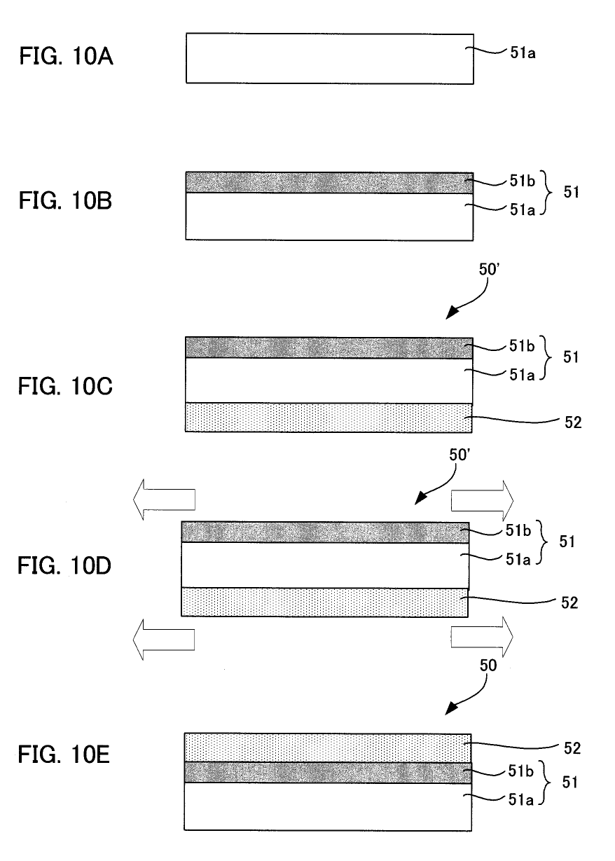

With reference to some of the drawings, the retardation-film-producing method in the mode is described. FIGS. 10A to 10E are schematic views illustrating an example of the retardation-film-producing method in the mode. As illustrated in FIGS. 10A to 10E, the retardation-film-producing method in the mode includes an optical anisotropic film forming step (FIG. 10B) of using a transparent substrate 51a made of a cellulose derivative (FIG. 10A) and coating, on the transparent substrate 51a, an optical-anisotropic-layer-forming coating solution wherein an optical anisotropic material having a retardation exhibiting a wavelength dependency of a normal dispersion type is dissolved in a solvent, thereby forming an optical anisotropic film 51 wherein an optical anisotropic layer 51b is formed on the transparent substrate 51a, a retardation layer forming step (FIG. 10C) of forming, on the surface opposite to the optical-anisotropic-layer-51b-formed surface of the optical anisotropic film 51, which is formed in the optical anisotropic film forming step, a retardation layer 52 containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized, thereby forming an optical laminate 50′ wherein the retardation layer 52 is formed on the optical anisotropic film 51, and a stretching step (FIG. 10D) of stretching the optical laminate 50′, which is formed in the retardation layer forming step, thereby producing a retardation film 50 wherein the retardation layer 52 is formed on the optical anisotropic film 51 (FIG. 10E).

According to the invention, a substrate made of a cellulose derivative is used as the above-mentioned transparent substrate, thus, in the case of using the retardation film produced according to the invention as, for example, an inside polarizing plate protective film, a polarizing plate protective film made of a cycloolefin resin can be used as the corresponding outside polarizing plate protective film. Therefore, a polarizing plate very good in durability can be obtained.

Moreover, according to the invention, the retardation layer forming step is the step of forming, on the surface opposite to the optical-anisotropic-layer-formed surface of the optical anisotropic film, a retardation layer, thus, a layer very good in the performance of expressing retardation property can easily be formed as the retardation layer.

From such matters, according to the mode, it is possible to produce a retardation film capable of forming a polarizing plate very good in durability.

The retardation-film-producing method in the mode has at least the optical anisotropic film forming step, the stretching step, and the retardation layer forming step and may optionally have a different step.

The optical anisotropic film forming step and the stretching step in the mode are the same as described in the item “D-1. Producing method of a retardation film in the first mode”.

Accordingly, only the retardation layer forming step used in the mode will be described hereinafter.

The retardation layer forming step used in the mode is described. The step is a step of forming, on the surface opposite to the optical-anisotropic-layer-formed surface of the optical anisotropic film, which is stretched in the stretching step, a retardation layer containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized.

The method for forming the retardation layer on the optical anisotropic film in the step is not particularly limited as far as the method makes it possible to form, on the surface opposite to the optical-anisotropic-layer-formed surface, a retardation layer containing a liquid crystalline material, this layer being a layer wherein between the refractive indexes “nx” and “ny” in arbitrary directions “x” and “y” of the in-plane direction which are perpendicular to each other and the refractive index “nz” in the thickness direction, the relation of nx≦ny<nz is realized. This method is the same as described in the item “D-1. Producing method of a retardation film in the first mode” except that the retardation layer is formed on the surface opposite to the optical-anisotropic-layer-formed surface of the optical anisotropic film, thus, detailed description thereof is omitted herein.

E. Liquid Crystal Display

Next, the liquid crystal display of the invention is described. The liquid crystal display of the invention can be classified into four modes. Accordingly, hereinafter, the liquid crystal display of the invention will be divided into the individual modes, and the modes will be described.

E-1. Liquid Crystal Display in the First Mode

First, the liquid crystal display in the first mode of the invention is described. The liquid crystal display in the mode is characterized in that the retardation film of the invention is used.

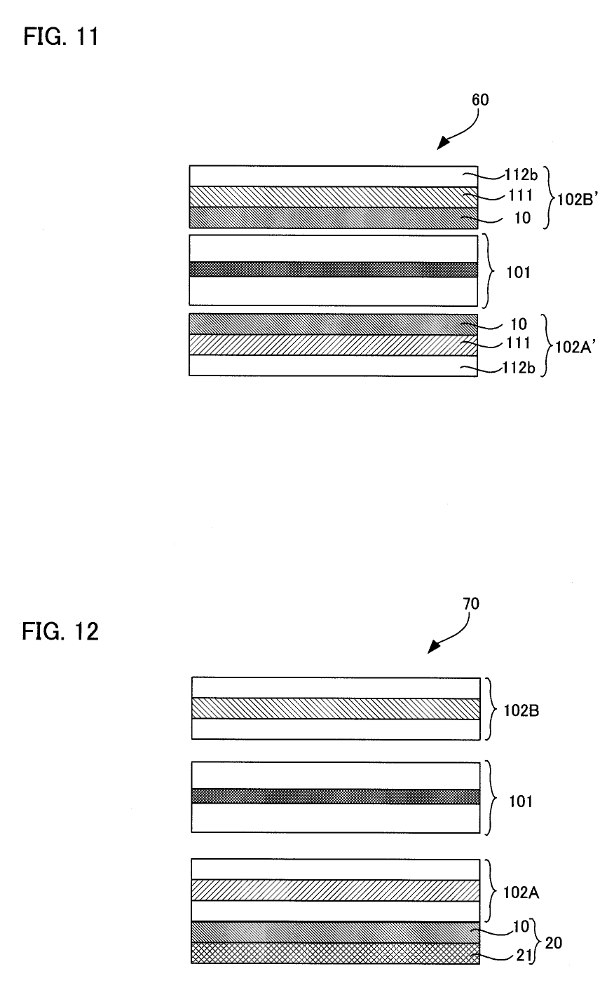

With reference to one of the drawings, the liquid crystal display in the mode is described. FIG. 11 is a schematic view illustrating an example of the liquid crystal display in the mode. As illustrated in FIG. 11, a liquid crystal display 60 in the mode has a liquid crystal cell 101, and polarizing plates 102A′ and 102B′ arranged on both surfaces of the liquid crystal cell 101, respectively.

In this example, about the liquid crystal display 60 in the mode, the polarizing plates 102A′ and 102B′ each have a structure wherein a polarizer 111 is sandwiched between a polarizing plate protective film 111b and a retardation film 10 of the invention.

According to the invention, the use of the retardation film of the invention makes it possible to yield a liquid crystal display very good in durability and viewing angle property.

The form that the retardation film of the invention is used in the liquid crystal display in the mode is not particularly limited as far as the form is a form making it possible to set the viewing angle property of the liquid crystal display of the invention into a desired degree. Examples of this form include a form that the above-mentioned retardation film is arranged between the liquid crystal cell and each of the polarizing plates, and a form that the above-mentioned retardation film is used as each of polarizing plate protective films which constitute the two polarizing plates between which the liquid crystal cell is sandwiched. In the mode, either one of these forms can be preferably used. The latter form is preferable. The use of the retardation film of the invention in the latter mode makes it possible to make the liquid crystal display in the mode thin.

When the retardation film of the invention is used as one of the polarizing plate protective films, the retardation film of the invention may be used as inside one of the polarizing plate protective films, or may be used as outside one thereof. In the mode, it is preferable to use the retardation film as the inside polarizing plate protective film. This makes it possible that a polarizing plate protective film made of a cycloolefin resin or the like is used as the outside polarizing plate protective film, thereby rendering the liquid crystal display in the mode a display better in durability.

The liquid crystal cell, the polarizing plates, and others used in the mode are the same as used in ordinary liquid crystal displays, thus, detailed description is omitted herein.

E-2. Liquid Crystal Display in the Second Mode

Next, the liquid crystal display in the second mode of the invention is described. The liquid crystal display in the mode is characterized in that the brightness enhancement film of the invention is used.

With reference to one of the drawings, the liquid crystal display in the mode is described. FIG. 12 is a schematic view illustrating an example of the liquid crystal display in the mode. As illustrated in FIG. 12, a liquid crystal display 70 in the mode has a liquid crystal cell 101, and polarizing plates 102A and 102B arranged on both surfaces of the liquid crystal cell 101, respectively, and further a brightness enhancement film 20 of the invention is arranged on the polarizing plate 102A.

According to the invention, the use of the brightness enhancement film of the invention makes it possible to yield a liquid crystal display very good in brightness property.

The form that the brightness enhancement film of the invention is used in the liquid crystal display in the mode is not particularly limited as far as the form is a form that a brightness enhancement film is ordinarily used in a liquid crystal display.

The liquid crystal cell, the polarizing plates, and others used in the mode are the same as used in ordinary liquid crystal displays, thus, detailed description is omitted herein.

E-3. Liquid Crystal Display in the Third Mode

Next, the liquid crystal display in the third mode of the invention is described. The liquid crystal display in the mode is characterized in that the polarizing plate of the invention is used.

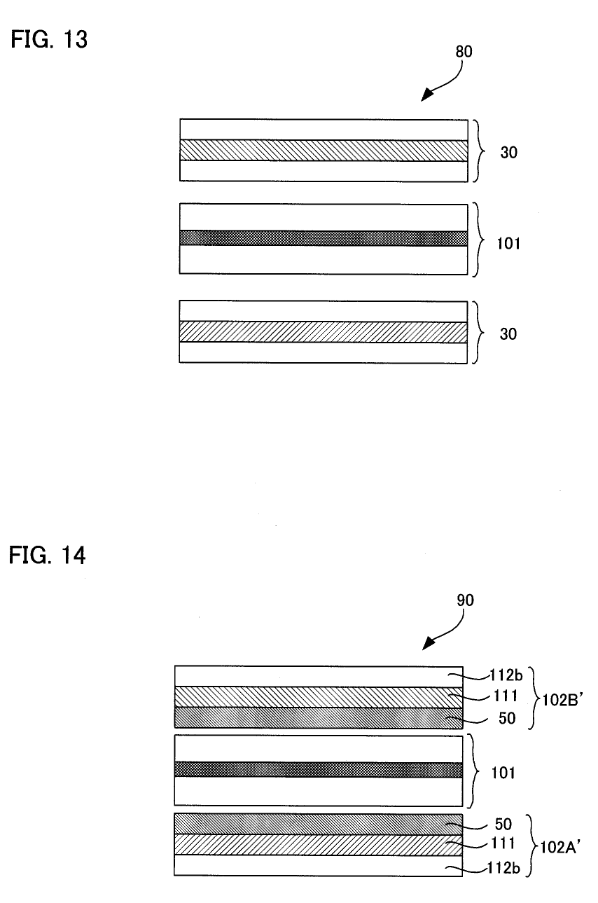

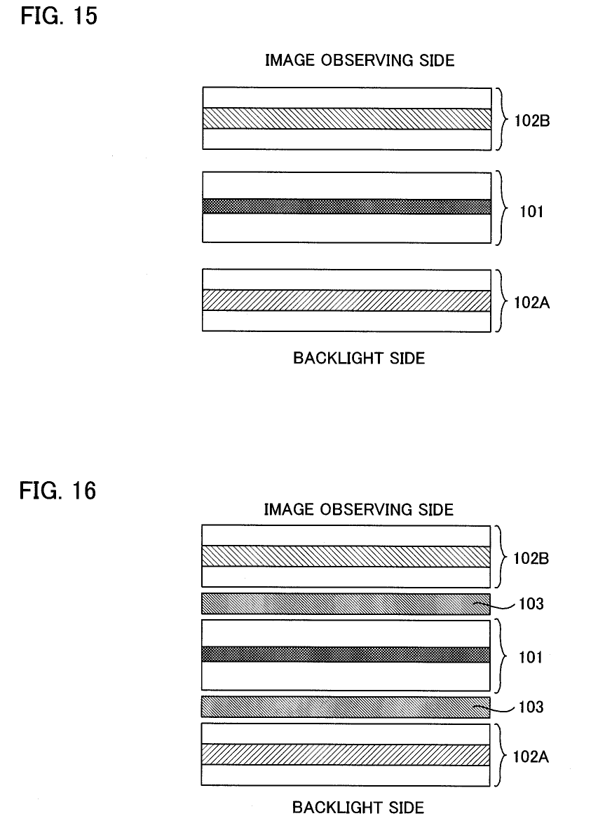

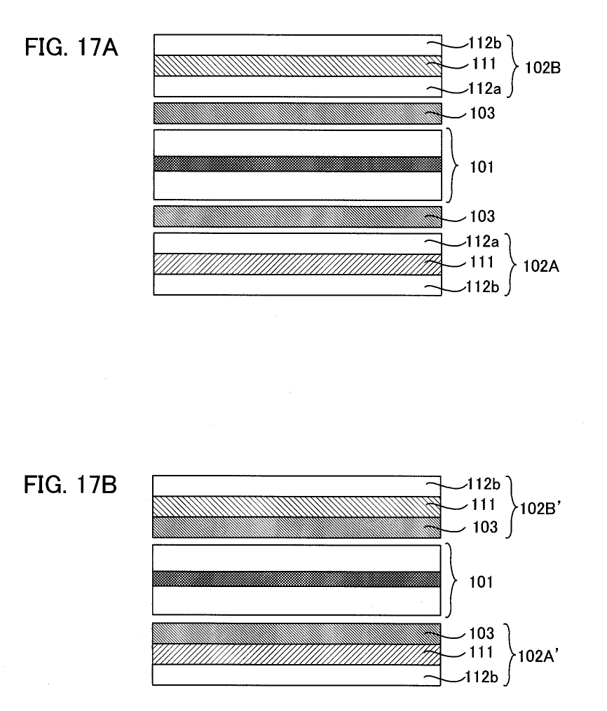

With reference to one of the drawings, the liquid crystal display in the mode is described. FIG. 13 is a schematic view illustrating an example of the liquid crystal display in the mode. As illustrated in FIG. 13, a liquid crystal display 80 in the mode has a liquid crystal cell 101, and polarizing plates 30 arranged on both surfaces of the liquid crystal cell 101, respectively.

According to the mode, the use of the polarizing plate of the invention makes it possible to yield a liquid crystal display very good in durability and viewing angle property.

The form that the polarizing plate of the invention is used in the liquid crystal display in the mode may be a form that the polarizing plate of the invention is used as each of the two polarizing plates used in the liquid crystal display in the mode, or a form that the polarizing plate of the invention is used as one of the two polarizing plates. In the mode, it is preferable that the polarizing plate of the invention is used as each of the two polarizing plates. This makes it possible to render the liquid crystal display in the mode a display better in durability.

The liquid crystal cell, the polarizing plates, and others used in the mode are the same as used in ordinary liquid crystal displays, thus, detailed description is omitted herein.

E-4. Liquid Crystal Display in the Fourth Mode

Next, the liquid crystal display in the fourth mode of the invention is described. The liquid crystal display in the mode is characterized in that the retardation film produced by the retardation-film-producing method of the invention is used.

With reference to one of the drawings, the liquid crystal display in the mode is described. FIG. 14 is a schematic view illustrating an example of the liquid crystal display in the mode. As illustrated in FIG. 14, a liquid crystal display 90 in the mode has a liquid crystal cell 101, and polarizing plates 102A′ and 102B′ arranged on both surfaces of the liquid crystal cell 101, respectively.

In this example, about the liquid crystal display 90 in the mode, the polarizing plates 102A′ and 102B′ each have a structure wherein a polarizer 111 is sandwiched between a polarizing plate protective film 111b and a retardation film 50 produced by the retardation-film-producing method of the invention.

According to the mode, the use of the retardation film produced by the retardation-film-producing method of the invention makes it possible to yield a liquid crystal display very good in durability and viewing angle property.

The form that the retardation film produced by the retardation-film-producing method of the invention is used in the liquid crystal display in the mode is not particularly limited as far as the form is a form making it possible to set the viewing angle property of the liquid crystal display in the mode into a desired degree. Examples of this form include a form that the above-mentioned retardation film is arranged between the liquid crystal cell and each of the polarizing plates, and a form that the above-mentioned retardation film is used as each of polarizing plate protective films which constitute the two polarizing plates between which the liquid crystal cell is sandwiched. In the mode, either one of these forms can be preferably used. The latter form is preferable. The use of the retardation film of the invention in the latter form makes it possible to make the liquid crystal display in the mode thin.

When the retardation film produced by the retardation-film-producing method of the invention is used as one of the polarizing plate protective films, the retardation film may be used as inside one of the polarizing plate protective films, or may be used as outside one thereof. In the mode, it is preferable to use the retardation film as the inside polarizing plate protective film. This makes it possible that a polarizing plate protective film made of a cycloolefin resin or the like is used as the outside polarizing plate protective film, thereby rendering the liquid crystal display in the mode a display better in durability.

The liquid crystal cell, the polarizing plates, and others used in the mode are the same as used in ordinary liquid crystal displays, thus, detailed description is omitted herein.

The invention is not limited to the above-mentioned embodiments. The embodiments are illustrative, and any embodiment having substantially the same structure as the technical concept recited in the claims of the invention and producing the same effects and advantageous as the embodiments is included in the technical scope of the invention.

### EXAMPLES

The invention will be more specifically described by way of the following examples.

### (1) Example 1

A urethane acrylate monomer having a storage tensile elastic modulus of 3.5×10² MPa was dissolved in methyl ethyl ketone to give a concentration of 40% by mass, and further thereto was added a polymerization initiator in an amount of 4% by mass of solid contents therein, so as to prepare an optical-anisotropic-film-forming coating solution. Next, a TAC (abbreviated name of triacetylcellulose) film substrate (thickness: 80 μm) having a storage tensile elastic modulus of 2.7×10³ MPa was used as a transparent substrate, and the optical-anisotropic-film-forming coating solution was coated on a surface of the TAC film substrate by bar coating. Next, the resultant was heated at 90° C. for 4 minutes to dry and remove the solvent. Ultraviolet rays were radiated onto the coated surface, thereby immobilizing the urethane acrylate monomer to form an optical laminate 6 μm in thickness after the drying. Thereafter, while the optical laminate was heated at 165° C., a stretching test machine was used to stretch the optical laminate monoaxially in the in-plane direction to give a stretch ratio of 1.4. In this way, an optical anisotropic film wherein an optical anisotropic layer was laminated on the transparent substrate was produced.

Next, a liquid crystal mixture composed of 50% by mass of a side chain type polymer represented by a formula (A) illustrated below and 50% by mass of a photopolymerizable liquid crystal represented by a formula (B) illustrated below, and a photopolymerization initiator (IRGACURE 907, manufactured by Ciba Specialty Chemicals; 5% by mass of the photopolymerizable compound) were dissolved into a cyclohexanone solution to set the concentration of solids therein to 20% by mass. Furthermore, a leveling agent was added thereto so as to yield a retardation-layer-forming coating solution. The retardation-layer-forming coating solution was coated onto the optical anisotropic layer. Thereafter, the resultant was dried at 100° C. for 1 minute, and cooled to room temperature as it was, so as to align the liquid crystal mixture into a homeotropic alignment state. Furthermore, the resultant was cured by UV having a power of 100 mJ/cm² to form a retardation layer 1 μm in thickness onto the optical anisotropic layer, thereby producing a retardation film.

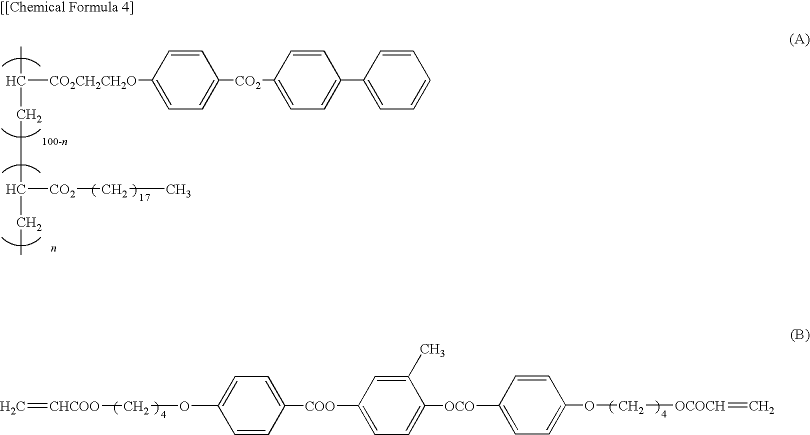

### (2) Example 2

A liquid crystal mixture containing liquid crystal materials represented by formulae (C), (D) and (E) illustrated below, and a photopolymerization initiator (IRGACURE 907, manufactured by Ciba Specialty Chemicals; 5% by mass of the liquid crystal compound) were dissolved into a cyclohexanone solution to set the concentration of solids therein to 20% by mass. Furthermore, a leveling agent was added thereto so as to yield a retardation-layer-forming coating solution. Next, the retardation-layer-forming coating solution was coated onto a glass substrate on which a vertically aligned layer was formed. Thereafter, the resultant was dried at 60° C. for 2 minutes so as to align the liquid crystal mixture into a homeotropic alignment state. Furthermore, the resultant was cured by UV having a power of 100 mJ/cm² to form a retardation layer 1 μm in thickness.

Next, the retardation layer was peeled off from the glass substrate, and then caused to adhere onto the optical anisotropic layer of the optical anisotropic film described in Example 1 through an adhesive agent, thereby forming a retardation film.

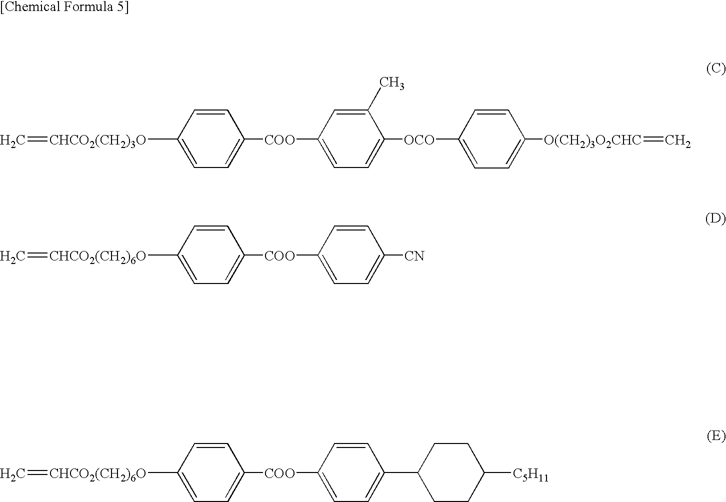

### (3) Example 3

A caprolactone-modified urethane acrylate monomer having a storage tensile elastic modulus of 5.1×10² MPa was dissolved in methyl ethyl ketone to give a concentration of 40% by mass, and further thereto was added a polymerization initiator in an amount of 4% by mass of solids therein, so as to prepare an optical-anisotropic-film-forming coating solution.

Next, a TAC film substrate (thickness: 80 μm) having a storage tensile elastic modulus of 2.7×10³ MPa was used as a transparent substrate, and the optical-anisotropic-film-forming coating solution was coated on a surface of the TAC film substrate by bar coating.

Thereafter, the resultant was heated at 90° C. for 4 minutes to dry and remove the solvent. Ultraviolet rays were radiated onto the coated surface, thereby immobilizing the caprolactone-modified urethane acrylate monomer to form an optical anisotropic film 6 μm in thickness after the drying.

In this way, an optical laminate wherein the optical anisotropic layer was laminated on the transparent substrate was formed.

Next, while the optical laminate was heated at 165° C., a stretching test machine was used to stretch the optical laminate monoaxially in the in-plane direction to give a stretch ratio of 1.4. In this way, an optical anisotropic film was produced.

The retardation layer described in Example 2 was caused to adhere onto the optical anisotropic layer of the optical anisotropic film through an adhesive agent, so as to produce a retardation film.

### (4) Example 4

A mixture of a photopolymerizable liquid crystal compound represented by a formula (B) illustrated below and the photopolymerization initiator described in Example 2 (5% by mass of the liquid crystal compound) was used as the optical anisotropic film material, and this was dissolved into cyclohexanone to give a concentration of 20% by mass. The solution was coated onto a surface of a TAC film (trade name: TF80UL, manufactured by Fuji Photo Film Co., Ltd.) substrate by bar coating, so as to give a coating amount of 2.0 g/m² after drying described below.

Next, the resultant was heated at 90° C. for 4 minutes to dry and remove the solvent. Ultraviolet rays were radiated onto the coated surface, there by immobilizing the photopolymerizable liquid crystal compound to form an optical laminate.

While the optical laminate was heated at 150° C., a stretching test machine was used to stretch the optical laminate monoaxially in the in-plane direction to give a stretch ratio of 1.25. In this way, an optical anisotropic film was produced.

The retardation layer described in Example 2 was caused to adhere onto the optical anisotropic layer of the optical anisotropic film through an adhesive agent, so as to produce a retardation film.

### (5) Example 5

The mixture of the photopolymerizable liquid crystal compound and the photopolymerization initiator used in Example 4 was used, and this was dissolved into cyclopentanone to give a concentration of 20% by mass. The resultant was subjected to the same coating and stretching treatment as in Example 4.

The retardation-layer-forming coating solution described in Example 1 was coated onto the optical anisotropic layer of the optical anisotropic film, and the resultant was dried at 60° C. for 2 minutes so as to align the liquid crystal mixture into a homeotropic alignment state. Furthermore, the resultant was cured by UV having a power of 100 mJ/cm² to form a retardation layer 1 μm in thickness. In this way, a retardation film was produced.

### (6) Example 6

The mixture of the photopolymerizable liquid crystal compound and the photopolymerization initiator used in Example 4 was used, and this was dissolved into methyl ethyl ketone to give a concentration of 20% by mass. The resultant was subjected to the same coating and stretching treatment as in Example 4.

The retardation layer described in Example 2 was caused to adhere onto the optical anisotropic layer of the optical anisotropic film through an adhesive agent, so as to produce a retardation film.

### (7) Example 7

The mixture of the photopolymerizable liquid crystal compound and the photopolymerization initiator used in Example was used, and this was dissolved into methyl acetate to give a concentration of 20% by mass. The resultant was subjected to the same coating and stretching treatment as in Example 4.

The retardation layer described in Example 2 was caused to adhere onto the optical anisotropic layer of the optical anisotropic film through an adhesive agent, so as to produce a retardation film.

### (8) Example 8

The mixture of the photopolymerizable liquid crystal compound and the photopolymerization initiator used in Example 4 was used, and this was dissolved into cyclohexanone to give a concentration of 20% by mass. The resultant solution was coated in the same way as in Example 4. The retardation-layer-forming coating solution described in Example 1 was coated onto the optical anisotropic layer of the optical anisotropic film, and the resultant was dried at 60° C. for 2 minutes so as to align the liquid crystal mixture into a homeotropic alignment state. Furthermore, the resultant was cured by UV having a power of 100 mJ/cm² to form a retardation layer 1 μm in thickness. In this way, an optical laminate was produced.

Next, while the optical laminate was heated at 150° C., a stretching test machine was used to stretch the optical laminate monoaxially in the in-plane direction to give a stretch ratio of 1.25. In this way, a retardation film was produced.

### (9) Example 9

A mixture of a photopolymerizable liquid crystal compound represented by a formula (F) illustrated below and the photopolymerization initiator used in Example 4 was used, and this was dissolved into a mixed solvent of cyclohexanone and cyclopentanone to give a concentration of 20% by mass. The resultant was subjected to the same coating and stretching treatment as in Example 4.

The retardation-layer-forming coating solution described in Example 1 was coated onto the optical anisotropic layer of the optical anisotropic film, and the resultant was dried at 60° C. for 2 minutes so as to align the liquid crystal mixture into a homeotropic alignment state. Furthermore, the resultant was cured by UV having a power of 100 mJ/cm² to form a retardation layer 1 μm in thickness. In this way, a retardation film was produced.

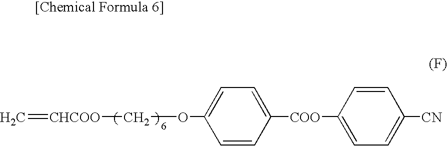

### (10) Example 10

A mixture of the photopolymerizable liquid crystal compound represented by the formula (F) and the photopolymerization initiator used in Example 4 was used, and this was dissolved into a mixed solvent of cyclohexanone and cyclopentanone to give a concentration of 20% by mass. The resultant was subjected to the same coating and stretching treatment as in Example 4.

The retardation-layer-forming coating solution described in Example 1 was coated onto the surface opposite to the optical-anisotropic-layer-formed surface of the optical anisotropic film, and the resultant was dried at 60° C. for 2 minutes so as to align the liquid crystal mixture into a homeotropic alignment state. Furthermore, the resultant was cured by UV having a power of 100 mJ/cm² to form a retardation layer 1 μm in thickness. In this way, a retardation film was produced.

### (11) Example 11

The mixture of the photopolymerizable liquid crystal compound and the photopolymerization initiator used in Example 4 was used, and this was dissolved into cyclohexanone to give a concentration of 20% by mass. The resultant solution was coated in the same way as in Example 4. The retardation-layer-forming coating solution described in Example 1 was coated onto the optical anisotropic film surface opposite to the optical anisotropic layer of the film. The resultant was dried at 60° C. for 2 minutes so as to align the liquid crystal mixture into a homeotropic alignment state. Furthermore, the resultant was cured by UV having a power of 100 mJ/cm² to form a retardation layer 1 μm in thickness. In this way, an optical laminate was produced.

Next, the optical laminate was subjected to the same stretching in Example 8 to produce a retardation film.

### (12) Example 12

A urethane acrylate monomer (Aronix: M1600, manufactured by Toagosei Co., Ltd.) was dissolved into methyl ethyl ketone to give a concentration of 40% by weight. Furthermore, thereto was added a polymerization initiator in an amount of 4% by weight of solids therein to prepare an overcoat-layer-forming coating solution. The overcoat-layer-forming coating solution was coated onto the retardation layer side surface of the retardation film produced in Example 5, and the resultant was heated at 90° C. for 4 minutes to dry and remove the solvent. Ultraviolet rays were radiated onto the coated solution to immobilize the urethane acrylate monomer to form an overcoat layer 4 μm in thickness after the drying. In this way, a retardation film was yielded.

### (13) Example 13

The overcoat-layer-forming coating solution prepared in Example 11 was coated onto the retardation layer side surface of the retardation film produced in Example 10 in accordance with the process in Example 11, so as to form an overcoat layer 4 μm in thickness after the layer was dried. In this way, a retardation film was yielded.

### (14) Comparative Example

A substrate (trade name: ZEONOA, manufactured by Zeon Corp.), made of a norbornene resin having a Re of 80 nm, was used as an optical anisotropic film, and a retardation layer was formed onto the optical anisotropic film in the same way as in Example 1 to yield a retardation film.

### (15) Evaluations

About the retardation films produced in Examples and Comparative Example described above, the homeotropic alignment property, the Re ratio of the in-plane retardation, and the haze were evaluated. About the homeotropic alignment property evaluation, an automatic birefringence measuring device KOBRA was used to calculate the “nx”, the “ny” and the “nz” of each of the retardation films, and then in a case where nx>nz>ny was satisfied, it was decided that a positive C-plate function was given. The Re ratio was measured by use of the KOBRA. The haze was measured with a “Haze-gard 2” manufactured by Toyo Seiki Kogyo Co., Ltd.

Moreover, a polarizing plate was produced, using each of the retardation films as a polarizing plate protective film on one of both sides thereof. The polarizing plate was allowed to standstill for 100 hours in an environment 90° C. in temperature and 90% RH in humidity. In this way, an environment test was made to evaluate the picture frame unevenness thereof. In the picture frame unevenness evaluation, light leakage was evaluated with the naked eye when black display was made.

When each of the retardation films of Examples 1 to 4 was used to produce the polarizing plate, a polarizing plate protective film made of a cycloolefin resin was able to be used as a polarizing plate protective film on the other side.

However, when the retardation film produced in Comparative Example 1 was used to produce the polarizing plate, it was unavoidable from the viewpoint of water permeability to use a polarizing plate protective film made of triacetylcellulose as a polarizing plate protective film on the other side.

The results of the evaluations are shown in Table 1.

TABLE 1

| | | | Picture | |
|---|---|---|---|---|
| | Alignment | | frame | |
| | property | Re ratio | unevenness | Haze (%) |
| Example 1 | ◯ | 0.94 | ◯ | 0.4 |
| Example 2 | ◯ | 0.94 | ◯ | 0.5 |
| Example 3 | ◯ | 0.86 | ◯ | 0.3 |
| Example 4 | ◯ | 1.02 | ◯ | 0.5 |
| Example 5 | ◯ | 1.02 | ◯ | 0.5 |
| Example 6 | ◯ | 1.02 | ◯ | 1 |
| Example 7 | ◯ | 1.02 | ◯ | 2 |
| Example 8 | ◯ | 1.02 | ◯ | 0.5 |
| Example 9 | ◯ | 1.07 | ◯ | 0.7 |
| Example 10 | ◯ | 1.02 | ◯ | 0.5 |
| Example 11 | ◯ | 1.02 | ◯ | 0.7 |
| Example 12 | ◯ | 1.02 | ◯ | 0.5 |
| Example 13 | ◯ | 1.02 | ◯ | 0.5 |
| Comparative | ◯ | 1 | X | 0.4 |
| Example | | | | |

1-20. (canceled)

21. A retardation film, comprising:
an optical anisotropic film, in which a relation of nx>ny is realized between a refractive index “nx” in a slow axis direction of an in-plane direction and a refractive index “ny” in a fast axis direction of the in-plane direction; and
a retardation layer formed on the optical anisotropic film and containing a liquid crystalline material, in which a relation of nx≦ny<nz is realized between refractive indexes “nx” and “ny” in arbitrary directions “x” and “y” of an in-plane direction which are perpendicular to each other and a refractive index “nz” in a thickness direction,
wherein the optical anisotropic film uses a transparent substrate comprising a cellulose derivative.

22. The retardation film according to claim 21, wherein the optical anisotropic film has:
the transparent substrate, and
an optical anisotropic layer formed on the transparent substrate and containing a urethane resin.

23. The retardation film according to claim 21, wherein the optical anisotropic film has:
the transparent substrate, and
an optical anisotropic layer formed on the transparent substrate and containing the cellulose derivative, which constitutes the transparent substrate, and an optical anisotropic material having a retardation exhibiting a wavelength dependency of a normal dispersion type.

24. The retardation film according to claim 23, wherein the optical anisotropic material contains a monofunctional polymerizable liquid crystal compound having, in a molecule thereof, a single polymerizable functional group.

25. The retardation film according to claim 21, wherein the cellulose derivative is triacetylcellulose.

26. A brightness enhancement film, comprising:
the retardation film as recited in claim 21, and
a cholesteric liquid crystal layer formed on the retardation layer of the retardation film, and containing a liquid crystalline material in a cholesteric sequence state.

27. A polarizing plate, comprising:
the retardation film as recited in claim 21,
a polarizer formed on the optical anisotropic film of the retardation film, and on a side opposite to the retardation-layer-formed side of the optical anisotropic film, and
a polarizing plate protective film formed on the polarizer.

28. A polarizing plate, comprising:
the brightness enhancement film as recited in claim 26,
a polarizer formed on the optical anisotropic film of the brightness enhancement film, and on a side opposite to the retardation-layer-formed side of the optical anisotropic film, and
a polarizing plate protective film formed on the polarizer.

29. The polarizing plate according to claim 27, wherein the polarizing plate protective film comprises a cycloolefin resin or an acrylic resin.

30. A producing method of a retardation film, comprising steps of:
an optical anisotropic film forming step of using a transparent substrate comprising a cellulose derivative, coating on the transparent substrate an optical-anisotropic-layer-forming coating solution in which an optical anisotropic material having a retardation exhibiting a wavelength dependency of a normal dispersion type is dissolved in a solvent, and thereby forming an optical anisotropic film in which an optical anisotropic layer is formed on the transparent substrate;
a stretching step of stretching the optical anisotropic film formed in the optical anisotropic film forming step; and
a retardation layer forming step of forming, on the optical anisotropic layer of the optical anisotropic film stretched in the stretching step, a retardation layer containing a liquid crystalline material, in which a relation of nx≦ny<nz is realized between refractive indexes “nx” and “ny” in arbitrary directions “x” and “y” of an in-plane direction which are perpendicular to each other and a refractive index “nz” in a thickness direction.

31. A producing method of a retardation film, comprising steps of:
an optical anisotropic film forming step of using a transparent substrate comprising a cellulose derivative, coating on the transparent substrate an optical-anisotropic-layer-forming coating solution in which an optical anisotropic material having a retardation exhibiting a wavelength dependency of a normal dispersion type is dissolved in a solvent, and thereby forming an optical anisotropic film in which an optical anisotropic layer is formed on the transparent substrate;
a retardation layer forming step of forming, on the optical anisotropic layer of the optical anisotropic film formed in the optical anisotropic film forming step, a retardation layer containing a liquid crystalline material, in which a relation of nx≦ny<nz is realized between refractive indexes “nx” and “ny” in arbitrary directions “x” and “y” of an in-plane direction which are perpendicular to each other and a refractive index “nz” in a thickness direction, thereby forming an optical laminate in which the retardation layer is formed on the optical anisotropic layer; and
a stretching step of stretching the optical laminate formed in the retardation layer forming step.

32. A producing method of a retardation film, comprising steps of:
an optical anisotropic film forming step of using a transparent substrate comprising a cellulose derivative, coating on the transparent substrate an optical-anisotropic-layer-forming coating solution in which an optical anisotropic material having a retardation exhibiting a wavelength dependency of a normal dispersion type is dissolved in a solvent, and thereby forming an optical anisotropic film in which an optical anisotropic layer is formed on the transparent substrate;
a stretching step of stretching the optical anisotropic film formed in the optical anisotropic film forming step; and
a retardation layer forming step of forming, on a surface opposite to the optical-anisotropic-layer-formed surface of the optical anisotropic film stretched in the stretching step, a retardation layer containing a liquid crystalline material, in which a relation of nx≦ny<nz is realized between refractive indexes “nx” and “ny” in arbitrary directions “x” and “y” of an in-plane direction which are perpendicular to each other and a refractive index “nz” in a thickness direction.

33. A producing method of a retardation film, comprising steps of:
an optical anisotropic film forming step of using a transparent substrate comprising a cellulose derivative, coating on the transparent substrate an optical-anisotropic-layer-forming coating solution in which an optical anisotropic material having a retardation exhibiting a wavelength dependency of a normal dispersion type is dissolved in a solvent, and thereby forming an optical anisotropic film in which an optical anisotropic layer is formed on the transparent substrate;
a retardation layer forming step of forming, on a surface opposite to the optical-anisotropic-layer-formed surface of the optical anisotropic film formed in the optical anisotropic film forming step, a retardation layer containing a liquid crystalline material, in which a relation of nx≦ny<nz is realized between refractive indexes “nx” and “ny” in arbitrary directions “x” and “y” of an in-plane direction which are perpendicular to each other and a refractive index “nz” in a thickness direction, and thereby forming an optical laminate in which the retardation layer is formed on the optical anisotropic layer; and
a stretching step of stretching the optical laminate formed in the retardation layer forming step.

34. The producing method of a retardation film according to claim 30, wherein the solvent contains a ketone solvent having a boiling point of 100° C. or higher.

35. The producing method of a retardation film according to claim 31, wherein the solvent contains a ketone solvent having a boiling point of 100° C. or higher.

36. The producing method of a retardation film according to claim 32, wherein the solvent contains a ketone solvent having a boiling point of 100° C. or higher.

37. The producing method of a retardation film according to claim 33, wherein the solvent contains a ketone solvent having a boiling point of 100° C. or higher.

38. The producing method of a retardation film according to claim 34, wherein the ketone solvent is cyclopentanone or cyclohexanone.

39. The producing method of a retardation film according to claim 35, wherein the ketone solvent is cyclopentanone or cyclohexanone.

40. The producing method of a retardation film according to claim 36, wherein the ketone solvent is cyclopentanone or cyclohexanone.

41. The producing method of a retardation film according to claim 37, wherein the ketone solvent is cyclopentanone or cyclohexanone.

42. The producing method of a retardation film according to claim 30, wherein the cellulose derivative is triacetylcellulose.

43. The producing method of a retardation film according to claim 31, wherein the cellulose derivative is triacetylcellulose.

44. The producing method of a retardation film according to claim 32, wherein the cellulose derivative is triacetylcellulose.

45. The producing method of a retardation film according to claim 33, wherein the cellulose derivative is triacetylcellulose.

46. A liquid crystal display, wherein the retardation film as recited in claim 21 is used.

47. A liquid crystal display, wherein the brightness enhancement film as recited in claim 26 is used.

48. A liquid crystal display, wherein the polarizing plate as recited in claim 27 is used.

49. A liquid crystal display, wherein the polarizing plate as recited in claim 28 is used.

50. A liquid crystal display, wherein a retardation film produced by the retardation film producing method as recited in claim 30 is used.

51. A liquid crystal display, wherein a retardation film produced by the retardation film producing method as recited in claim 31 is used.

52. A liquid crystal display, wherein a retardation film produced by the retardation film producing method as recited in claim 32 is used.

53. A liquid crystal display, wherein a retardation film produced by the retardation film producing method as recited in claim 33 is used.
